(19) United States
(12) Patent Application Publication
(10) Pub. No.: US 2009/0210435 A1
(43) Pub. Date: Aug. 20, 2009

(54) CONFIGURATION ITEM MANAGEMENT TOOL

(75) Inventors: Kazuhito Akiyama, Tokyo (JP); Yasuhiro Suzuki, Tokyo (JP); Tadashi Tsumura, Kanagawa-ken (JP); Takeshi Fukuda, Tokyo (JP)

Correspondence Address: IBM CORP. (AUSTIN), C/O NELSON AND NELSON, 2984 E. EVERGREEN AVE., SALT LAKE CITY, UT, 84109, US

(73) Assignee: INTERNATIONAL BUSINESS MACHINES CORPORATION, Armonk, NY (US)

(21) Appl. No.: 12/363,193

(22) Filed: Jan. 30, 2009

(30) Foreign Application Priority Data
Feb. 18, 2008 (JP) 2008-36598

(51) Int. Cl. G06F 17/30

(52) U.S. Cl. 707/100; 707/E17.044; 707/E17.005

(57) ABSTRACT

A computer system is presented for managing a plurality of configuration items. A first computer may be connected to a second computer over a network. The first computer may manage configuration items conforming to a first specification, while the second computer may manage configuration items conforming to a second specification. A repository may store, for each of the configuration items, a set of data conforming to the first specification. The set of data may include one or more predetermined attributes of each configuration item, and at least one relationship between each configuration item and other configuration items. A discovery section may detect external reference data associated with configuration items conforming to the second specification. The set of data for each configuration item conforming to the second specification may be created from the external reference data and stored in the repository.

### BACKGROUND

The Information Technology Infrastructure Library (“ITIL,” a trademark of the United Kingdom Government) describes in detail some of the best practices for IT service management. Primary functions of the ITIL include service support and service delivery.

Configuration management is a type of service support that recognizes configuration items (“CIs”) requiring IT service management, such as maintaining, updating, checking, and monitoring configuration item information.

Configuration items subject to configuration management may include system resources, including both hardware and software. Configuration management may also manage facilities necessary for providing IT services, documents such as specifications on IT service management, operation manuals and schematic diagrams, maintenance information services, processes and human resources.

According to the ITIL framework, centralized management of configuration items using a configuration management database (“CMDB”) is recommended. A CMDB may store at least one attribute of each configuration item, and its relationships with other configuration items. The ability to automatically discover CI information, and automatically update or track such information, may be key to successfully implementing a CMDB. Indeed, it is important that a CMDB accurately reflect CI information.

CMDBs in IT service management are used as a standard of the IT industry. However, data to be stored in CMDBs, such as the schema of CI instances, varies among CMDB vendors. Such schema may include a description for defining the structure of database, which may be described by a formal language supported by a particular database management system (“DBMS”).

### SUMMARY

Embodiments of the invention have been developed to provide a computer system for managing various configuration items.

In certain embodiments, a first computer may be connected to a second computer over a network. The first computer may manage configuration items conforming to a first specification, while the second computer may manage configuration items conforming to a second specification. A repository may store, for each of the configuration items, a set of data conforming to the first specification. The set of data may include one or more predetermined attributes of each configuration item, and at least one relationship between each configuration item and other configuration items. A discovery section may detect external reference data associated with configuration items conforming to the second specification. The set of data for each configuration item conforming to the second specification may be created from the external reference data and stored in the repository.

A corresponding method and computer program product are also disclosed and claimed herein.

### BRIEF DESCRIPTION OF THE DRAWINGS

In order that the advantages of the disclosure will be readily understood, a more particular description of embodiments of the invention briefly described above will be rendered by reference to specific embodiments illustrated in the appended drawings. Understanding that these drawings depict only typical embodiments of the invention and are not therefore to be considered limiting of its scope, embodiments of the invention will be described and explained with additional specificity and detail through use of the accompanying drawings, in which:

FIG. 1 shows an example of a computer system including a CMDB;

FIG. 2A shows creation of CI instances of a device A and a device B and their relation instances;

FIG. 2B shows a data model, a discovery instance, a CI instance, and a relation model;

FIG. 2C shows an example in which reference of data is not allowed among CMDBs that manage data of different specifications;

FIG. 3 depicts a conceptual diagram of an embodiment of the invention in which a first computer system that manages data conforming to a first specification may manage a second computer system managing data conforming to a second specification;

FIG. 4 depicts the first computer system and the second computer system according to an embodiment of the invention;

FIG. 5A depicts an alias data model stored in an alias model table, and an alias relation model stored in an alias relation table, according to an embodiment of the invention;

FIG. 5B illustrates access right data, authorized object data, and notification data according to an embodiment of the invention;

FIG. 6 illustrates endpoint data according to an embodiment of the invention;

FIG. 7 shows an alias data model stored in a model table, an alias discovery data, an alias CI instance, and an alias relation model stored in a relation table according to an embodiment of the invention;

FIG. 8A is a flowchart illustrating an embodiment of the invention in which the managing system works the managed system to manage the data of the managed system;

FIG. 8B is a conceptual diagram of the embodiment of FIG. 8A;

FIG. 9A is a flowchart of an embodiment of the invention in which the managed system works the managing system to manage the data of the managed system;

FIG. 9B is a conceptual diagram of the embodiment of FIG. 9A;

FIG. 10A is a flowchart of embodiments of the invention in which the managing system detects external reference data of the managed system;

FIG. 10B shows a portion of the concept of an embodiment in which the managing system detects external reference data of the managed system;

FIG. 10C shows a remaining portion of the concept illustrated in FIG. 10B;

FIG. 10D shows the concept of an alternative embodiment of the invention in which the managing system detects external reference data of the managed system;

FIG. 11 shows an embodiment of the invention in which maintenance of a printer is outsourced; and

FIG. 12 shows an embodiment of the invention in which printer information is shared by a plurality of CMDBs.

### DETAILED DESCRIPTION OF THE INVENTION

It will be readily understood that the components of the embodiments of the invention, as generally described and illustrated in the Figures herein, could be arranged and designed in a wide variety of different configurations. Thus, the following more detailed description of the embodiments of the invention, as represented in the Figures, is not intended to limit the scope of the claims, but is merely representative of certain examples of presently contemplated embodiments in accordance with the invention. The presently described embodiments will be best understood by reference to the drawings, wherein like parts are designated by like numerals throughout.

As will be appreciated by one skilled in the art, embodiments of the invention may be embodied as an apparatus, method, or computer program product. Furthermore, the present invention may take the form of an entirely hardware embodiment, an entirely software embodiment (including firmware, resident software, micro-code, etc.) or an embodiment combining software and hardware elements. Hardware and/or software elements provided to perform various tasks may be generally referred to herein as “modules.” Furthermore, the present invention may take the form of a computer program product embodied in any tangible medium of expression having computer-usable program code embodied in the medium.

Any combination of one or more computer-usable or computer-readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (“RAM”), a read-only memory (“ROM”), an erasable programmable read-only memory (“EPROM” or Flash memory), an optical fiber, a portable compact disc read-only memory (“CDROM”), an optical storage device, transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to wireless, wireline, optical fiber cable, RF, etc.

Computer program code for carrying out operations of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Embodiments of the invention may enable a first computer system to manage data having specifications other than those stored in the CMDB of a second computer system. The first computer system may discover and track data of the configuration items to be managed by the second computer system. Particularly, the first computer system may discover and track external reference data associated with the data.

According to certain embodiments, a repository may store a set of data including at least one predetermined attribute of each configuration item, and relationships between the configuration items. In one embodiment, the repository may include a CMDB recording section storing a CMDB. Basic terms of the CMDB are described below.

Configuration Item (“CI”)

As used herein the term “configuration item” or “CI” refers to a base unit to be managed as the target of IT service management. Examples of a CI may include system resources, such as hardware and software, facilities necessary for providing IT services, documents such as specifications on IT service operation, operation manuals and schematic diagrams, maintenance information services, processes and human resources.

Configuration Management Database (CMDB)

The term “Configuration Management Database” or “CMDB” refers to a database that stores at least one predetermined attribute of each CI and its relationships with other CIs. While a CMDB is conceptually a database, it may physically take the form of a spreadsheet, spreadsheet software or the like. The use of the CMDB may make it easy for the administrator to understand the relationships between various CIs.

Configuration Item Instance (CI Instance)

The term “Configuration Item Instance” or “CI Instance” refers to data corresponding to a CI. Each CI instance may be represented on a CMDB as an instance of a data model. An example of the instance may be an instance of static data or a Java® class instance. A Java® class instance may be stored in an CMDB by, for example, a system called Java® data objects (“JDO”) for achieving the persistence of a Java® class instance and storing it in a hard disk. Accordingly, even if the power source of a computer system is temporarily turned off, the created Java® class instance may not be lost. When power is restored, the Java® class instance may be read from a storage unit, such as a hard disk, and developed on the main memory into a Java® class instance that can be changed or deleted by a Java® class program.

Data Model

The term “data model” refers to a schema for defining a CI, and may include an information model that provides a consistent definition of CIs to be managed and relationships between various CIs. Specifically, the data model may define an attribute of each CI and its relationships with other CIs, such as production equipment, processes, and the like. An example of a data model may include a data model for a configuration management database (“CDM”) proposed by IBM Corporation. The CDM may be implemented, for example, using Unified Modeling Language (“UML”).

Attribute

Attributes may specify and describe individual CIs in CI management. Examples of attributes may include, but are not limited to, the name of a CI (the generic name of the CI, for example, server, client, or firewall); product number ID, or a number for individually identifying a specific entity of the CI, such as a production number or serial number); category (classification of the CI, for example, hardware, software, or document); type (detailed classification of the category); type number (model number of the CI named by a provider); warranty period (provided by a CI provider); version number (of the CI); location (location of the CI, for example, a location where a PC is installed, an archive of software, a storage location of media, or a site that provides services); a person in charge (name of CI administrator); responsibility start date (date on which the owner administrator took charge of the CI); provider (developer or provider of the CI); license (license number or the number of licenses); provision date (date on which the CI was provided to the organization); acceptance date (date on which the CI was accepted by the organization); use start date (date on which the use of the CI was started); CI status (present status, for example, in operation, in testing, or in failure, or future status, such as an intended CI status); and status of a CI instance (valid or invalid); and/or any other such attributes known to those in the art.

Relation

The term “relation” or “relationship” refers to a relationship between CIs. A relation may be defined by a data model, like CIs. Examples of relations may include assigns, canConnect, canUse, connectAt, connects, controls, deployedOn, Located, Managed, Owned, provides, runAt, uses, usedBy, and any other relations or relationships known to those in the art.

In some embodiments of the invention, a CMDB may include a set of data. The set of data may include at least one predetermined attribute of each configuration item and its relations or relationships with other configuration items. In certain embodiments, data stored in the CMDB may conform to a particular specification or schema.

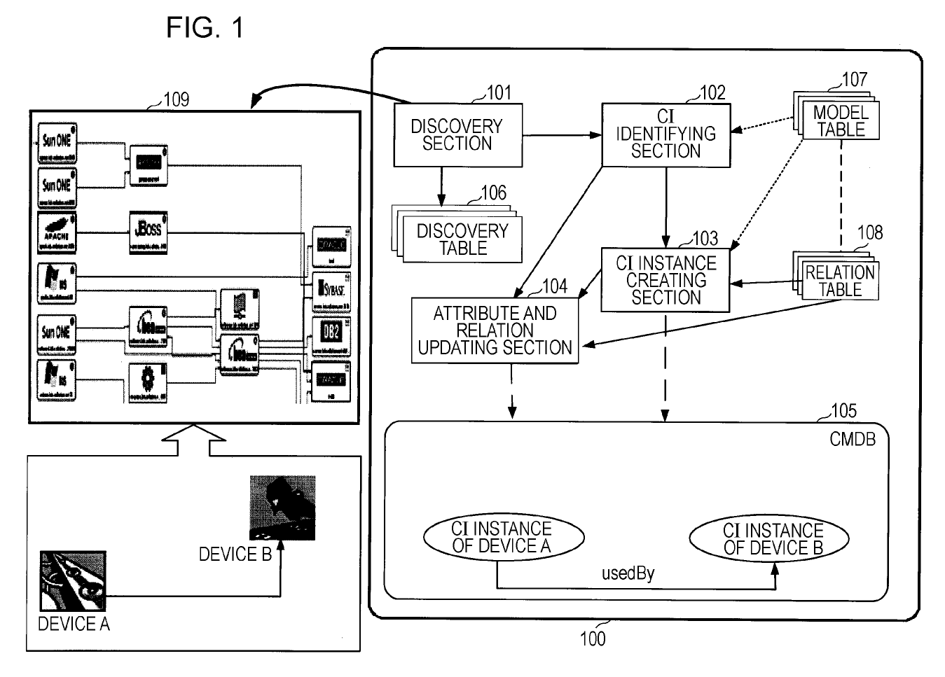

Referring now to FIG. 1, a computer system 100 may include a CMDB for managing CIs (for example, a device “A” and a device “B”). The computer system 100 may include a discovery section 101, a CI identifying section 102, a CI instance creating section 103, an attribute and relation updating section 104, and a CMDB 105.

The discovery section 101, the CI identifying section 102, the CI instance creating section 103, the attribute and relation updating section 104, and the CMDB 105 may be installed on a single computer or distributed over a plurality of computers. The computer system 100 may further include a discovery table 106, a model table 107, and a relation table 108. These tables may be likewise installed on a single computer or distributed over a plurality of computers.

As shown in FIG. 1, a console screen 109 may show a connection between the CIs. The connection between the CIs displayed on the screen 109 is provided as an example, and may not show all the connections between the CIs to be managed by the computer system 100.

The computer system 100 may manage only the configuration items that the computer system 100 may access or discover. The discovery section 101 may execute detection or discovery of information of the CIs, which are the objects to be managed by the CMDB. Some of the CIs are shown on the console screen 109 in the Figure.

In certain embodiments, the computer system 100 may include a plurality of discovery sections 101. The objects to be managed may be connected to the computer system 100 by a network. The network may be a cable-connection type or a wireless-connection type network.

The administrator of the computer system 100 may freely set an object to be detected. The range of the detection may be indicated by, for example, domain name, IP address, MAC address, device identifier, database name, or a combination thereof. If the CI to be managed is industrial equipment, information on the industrial equipment may be detected. The detected information may be information on a new CI, an updated attribute value or relation value of an existing CI. The new CI may be a CI detected by the discovery section 101 that has not been registered in the CMDB 105. An existing CI may be a CI whose instance has already been registered in the CMDB 105.

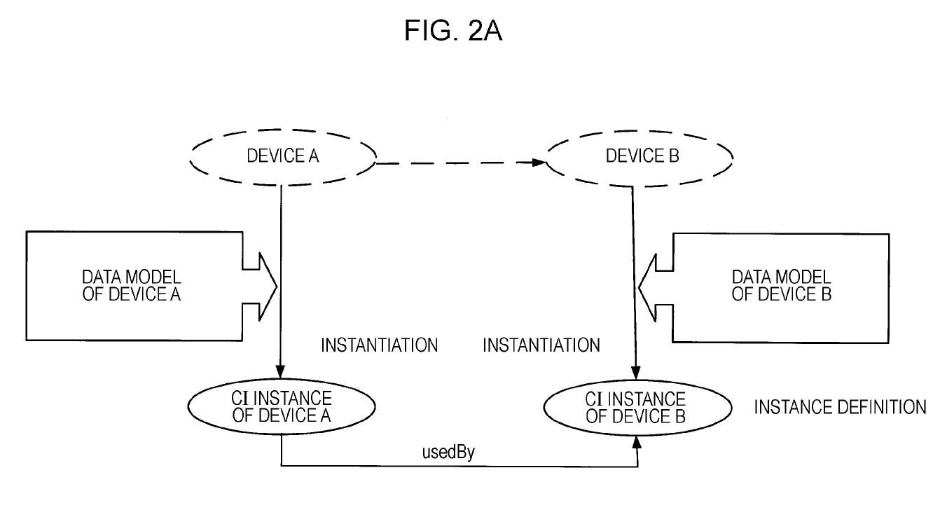

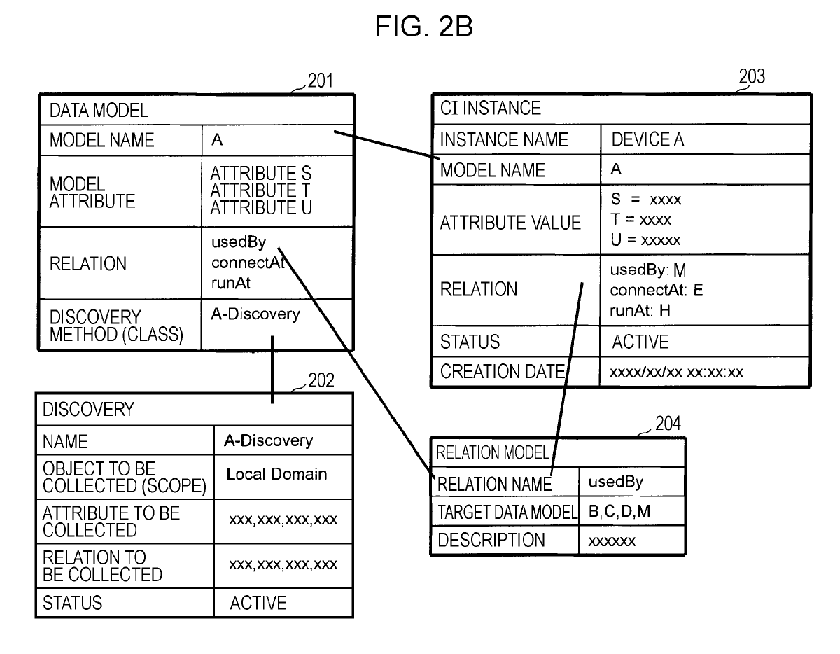

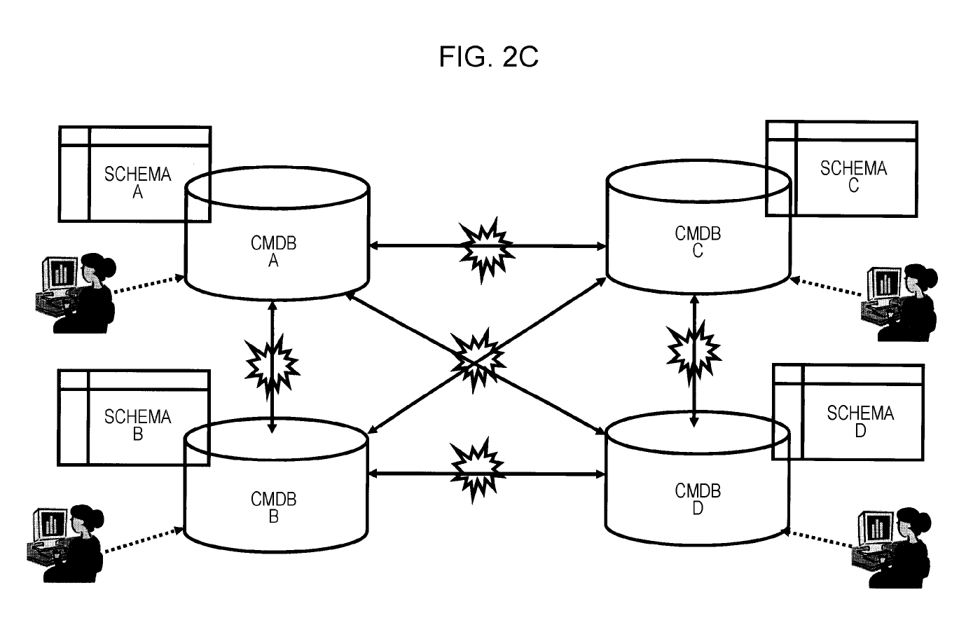

The discovery section 101 may detect information of the CI according to discovery data 202 (for example, A-Discovery in FIG. 2B) stored in the discovery table 106. The discovery data to be used may be specified by a discovery method in a data model 201, as discussed with reference to FIG. 2B below. The discovery section 101 may pass the detected CI information to the CI identifying section 102.

The CI identifying section 102 may receive the CI information from the discovery section 101 and process the detection result. The CI identifying section 102 may determine whether the CI information is information for a new CI, or an updated attribute or relation value for an existing CI, with reference to the CMDB 105. This determination may be executed, for example, by comparing the instance names of the CIs stored in the CMDB with the CI information. If the CI information is for a new CI, the CI identifying section 102 may pass the information to the CI instance creating section 103. In contrast, if the CI information is an updated attribute or relation value of an existing CI, the CI identifying section 102 may pass the information to the attribute and relation updating section 104.

The CI instance creating section 103 may create a set of data including an attribute of the CI and its relationships with other CIs. This data may be derived from the CI information in the data model 201 (FIG. 2B) stored in the model table 107, and a relation model 204 (FIG. 2B) stored in the relation table 108. The set of data may be instantiated according to the CI information detected by the discovery section 101 or manually input CI information, as discussed in more detail with reference to FIG. 2A below. In certain embodiments, the set of data may be implemented by an instance of static data or a Java® class instance. One example of the set of data is CI instance data, such as that shown in FIG. 2B. The set of data may be stored in the CMDB 105. The attributes and relations of the set of data may be stored in the CI instance 203, or the attributes may be stored in the CI instance data, while the relations may be stored as relation instance data in the CMDB 105. In the latter case, the CI instance may include a link for specifying a related relation instance.

The attribute and relation updating section 104 may track together with the discovery section 101. The attribute and relation updating section 104 may reflect the updated attribute or relation value of the CI to the CI instance of the CI stored in the CMDB. In other words, the attribute and relation updating section 104 may update the attribute or relation value of the CI instance of the CI. The update is executed by replacing the value with the CI information detected by the discovery section 101. The replacement may replace all the attribute or relation values of the CI instance with the CI information detected by the discovery section 101, or may replace different values only. The CMDB 105 may store the CI instance 203 of the CI, as shown in FIG. 2B.

The discovery table 106 may store the discovery data 202 (FIG. 2B). The discovery data 202 may be used when the discovery section 101 detects CI information. The discovery data 202 may be implemented by, for example, an instance of static data or a Java® class instance. The discovery data 202 may also be referred to as a discovery policy. The discovery data 202 (FIG. 2B) may include a range to be searched by the discovery section 101, that is, object to be collected (scope), attribute to be collected, and relation to be collected, which may be included in the search range for the CI (FIG. 2B).

The object to be collected may be specified using, for example, a subnet IP address, an IP address range, an IP address, a MAC address, a device identifier, a host name, a database, or a combination thereof. Alternatively, the object to be collected may be a schedule managing database (not shown), which is connected to the computer system 100 via a network. The schedule managing database may store, for example, data on process management for using devices. As a further alternative, the object to be collected may be a database (not shown) that stores a batch processing definition file. In the case where the object to be collected is a database that stores the batch processing definition file, the discovery section 101 may detect information by reading the content of the batch processing definition file. The batch processing definition file may store, for example, data of which device is to be used in what order.

The model table 107 may store the data model 201 (FIG. 2B). The data model 201 may be used when a set of data including an attribute of each CI and its relations with other CIs is created by the CI instance creating section 103.

The relation table 108 may store a relation model 204 (FIG. 2B). The relation model 204 may be used when a set of data indicative of an attribute of each CI and its relations with other CIs is created by the CI instance creating section 103.

As shown in FIG. 1, the discovery section 101 in one embodiment may detect a CI connected to the computer system 100 via a network, and may further detect a device A, a device B that uses the device A, and the relationship between the devices A and B. Then, after the CI identifying section 102 determines whether to create a CI instance, the CI instance creating section 103 may create the CI instance of the device A, the CI instance of the device B, and the instance of the relation (usedBy) of the devices A and B. The CI instance creating section 103 may then store the created instances in the CMDB 105.

Referring now to FIG. 2A, CI instances (for example, of the device A and device B) and the instance of the relation (usedBy) of the devices A and B may be created. The CI instance of the device A may be created by the CI instance creating section 103 upon detection of the device A by the discovery section 101. Likewise, the CI instance of the device B may be created by the CI instance creating section 103 upon detection of the device B by the discovery section 101. The data models of the devices A and B may be stored in the model table 107 shown in FIG. 1.

The relation (usedBy) between the devices A and B may be created by the CI instance creating section 103. This relation may be created according to the relation model, based on the information of the device A detected by the discovery section 101. The relation model may be stored in the relation table 108.

As shown in FIG. 2A, the CI instance of the device B may be created using the data model of the device B. However, if devices to be instantiated using the data model of the device B are devices B1, B2, and B3, information of the devices B1, B2, and B3 may be instantiated using the data model of the device B to form the CI instance of the device B 1, the CI instance of the device B2, and the CI instance of the device B3, respectively. The CI instances of the devices B1, B2, and B3 may also be stored in the CMDB 105.

Referring now to FIG. 2B, a data model 201 may be stored in the model table 107 (FIG. 1), discovery instance data 202 may be stored in the discovery table 106 (FIG. 1), the CI instance 203 may be stored in the CMDB 105 (FIG. 1), and the relation model 204 may be stored in the relation table 108 (FIG. 1).

The data model 201 may include a schema for defining CIs. For example, the data model 201 may include a “model name” that identifies the CI, a “model attribute” indicating an attribute of the CI designated by the model name, a “relation” indicating relations between the CI designated by the model name and other CIs, and a “discovery method” that specifies a discovery instance for detecting the CI designated by the model name.

In one embodiment, for example, the “model attribute” may include an attribute defined in IBM configuration management database model CDM. The administrator of the CMDB may designate any such attribute in the data model 201. Similarly, in another embodiment, a “relation” may be defined according to the relation defined by the CDM. The “discovery method” may be designated by a discovery instance name, such as A-Discovery, as shown in FIG. 2B.

The discovery instance 202 may include the “name” of the discovery instance specified by the discovery method in the data model 201, the “object to be collected (scope)”, the “attribute to be collected” and the “relation to be collected” of an object to be managed, and the “status” indicating whether the discovery instance is active or inactive.

The CI instance 203 may include an “instance name” for identifying the instance of the CI, a “model name” indicating which data model may be used to create the instance, an “attribute value” specified by the data model, a description (value) of each “relation” specified by the data model, a “status” indicative of whether the instance is active or inactive, and a “creation date” on which the CI instance was created.

In some embodiments, the CI instance may further include a CI instance identifier unique to the CI instance. The CI instance identifier may be, for example, a host name, a serial number, or a combination of other attributes having fixed values. As shown in FIG. 2B, the CI instance 203 may indicate that the CI instance derives from device A, that it is instantiated using a data model A, that it includes attributes S, T, and U having the respective values, that it is used by M (usedBy:M), connected to E (connectAt:E), and executed or run at H (runAt:H), that the CI instance is active, and may provide the creation date of the CI instance.

The relation model 204 may provide a schema for defining a relation specified by the data model 201. The relation model 204 may include a “relation name” such as “usedBy”, “target data model” for specifying data models which are targets of the relation, “description” of the relation, and the like.

Referring now to FIG. 2C, in some embodiments, cross-reference of data may not be allowed among CMDBs that manage data of different specifications (prior art). Data stored in CMDBs A, B, C, and D may include schemas A, B, C, and D of CI instances, respectively. The schemas A, B, C, and D of the CI instances may have different specifications. The computer systems having the CMDBs A, B, C and D, respectively, may be connected to one another via a network.

As shown in FIG. 2C, the computer systems that manage the respective CMDBs may access the CMDBs, and recognize only discovered objects as configuration items. For example, the computer system that manages the CMDB A may not refer to the data stored in the CMDBs B, C, and D. Accordingly, the computer system that manages the CMDB A may not refer to or detect attributes or relations of the configuration items to be managed by the CMDBs B, C, and D.

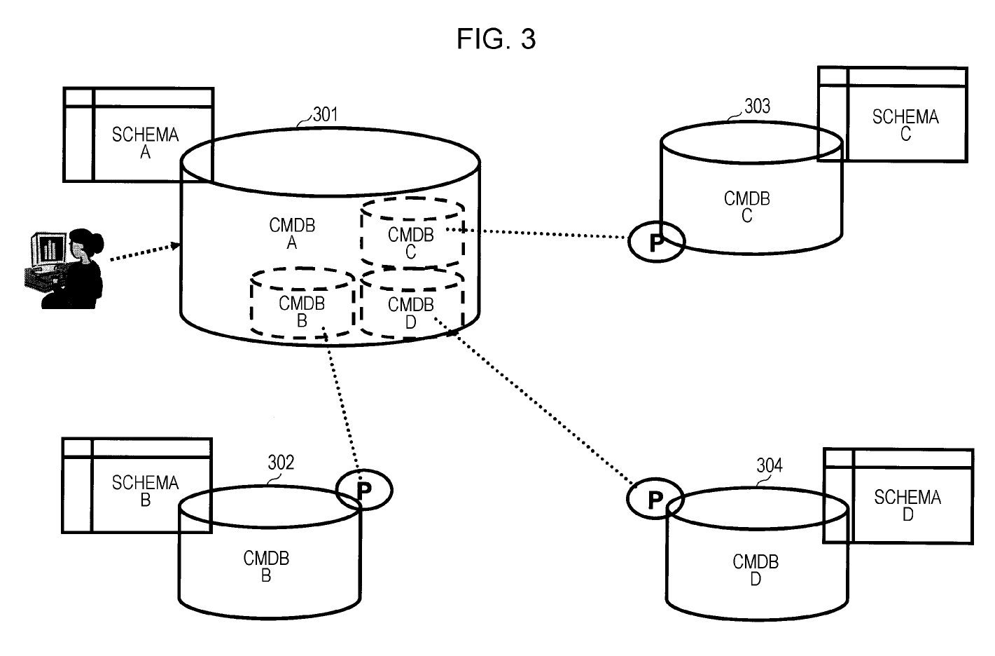

FIG. 3 shows a conceptual diagram of embodiments of the invention in which a computer system having data conforming to a first specification (hereinafter referred to as a “first computer system”) may manage a computer system having data conforming to a second specification (hereinafter referred to as a “second computer system”). The first computer system may be in peer-to-peer (“P2P”) relation with the second computer system.

In certain embodiments, the first computer system may discover and track external reference data of the second computer system. Specifically, the first computer system may store a set of data 301 conforming to the data specification of the CMDB A in its own CMDB A from the data in the CMDB B, the data in the CMDB C, and the data in the CMDB D, as if the CMDB A contains the CMDB B, the CMDB C, and the CMDB D.

In one embodiment, the first computer system may manage the data of the second computer system. In another embodiment, the second computer system may manage the data of the second computer system, and may delegate data management to the first computer system. Hereinafter, the first computer system may sometimes be referred to as a “managing system,” and the second computer system may sometimes be referred to as a “managed system.” The following description is common to both embodiments described above, unless otherwise specified.

The first computer system (not shown) may include the CMDB A 301. The schema of the CI instance stored in the CMDB A 301 may be A. The second computer system (not shown) may include the CMDB B 302, for example. The schema of the CI instance stored in the CMDB B 302 may be B. The schemas of the CI instances stored in the CMDB C 303 and the CMDB D 304 may be C and D, respectively. The specifications of the schemas A, B, C, and D may be different.

In accordance with embodiments of the invention, the second computer system may create external reference data B (associated with data conforming to the second specification) from the data stored in the CMDB B 302, and conforming to the schema B. Likewise, external reference data C may be created from the data stored in the CMDB B 303 and conforming to the schema C. Likewise, external reference data D may be created from the data stored in the CMDB D 304 and conforming to the schema D.

The external reference data may be created from information regarding the configuration items of the second computer system, that is, the second specification data. Accordingly, the external reference data may be perceived by the first computer system to be information regarding the configuration items of the second computer system. The external reference data, however, may not include all of the information regarding the configuration items of the second computer system.

For example, the external reference data may include at least one of the attributes and relations of the configuration items of the second computer system. In this case, the external reference data may include part of the information regarding the configuration items of the second computer system. In other words, the external reference data may not be information regarding the actual configuration items of the second computer system, but information regarding alias configuration items or virtual configuration items.

The alias configuration items of embodiments of the invention may indicate, for an external computer system (the first computer system), that external reference data may be either existent configuration items or nonexistent configuration items of the second computer system. Accordingly, the alias configuration items may also include part or all of the configuration items to be managed by the second computer system, or a combination of configuration items to which the first computer system may refer. In some embodiments, the external reference data may be information regarding an alias configuration item (hereinafter, referred to as an “alias CI”) of the second computer system.

The first computer system may detect external reference data associated with data conforming to the schema B, create an instance B for an alias CI (hereinafter, referred to as an “alias CI instance”) conforming to the schema A from the external reference data, and store the alias CI instance B in the CMDB A. Likewise, the first computer system may detect external reference data associated with data conforming to the schema C, create an alias CI instance C conforming to the schema A from the external reference data, and store the alias CI instance C in the CMDB A. Finally, the first computer system may detect external reference data associated with data conforming to the schema D, create an alias CI instance D conforming to the schema A from the external reference data, and store the alias CI instance D in the CMDB A.

Since the first computer system may store the external reference CI instance B conforming to the schema A in its own CMDB A, it may refer to the data of the CMDB B indirectly. Likewise, since the first computer system may store the external reference CI instance C conforming to the schema A in its own CMDB A, it may refer to the data of the CMDB C indirectly. Finally, since the first computer system stores the external reference CI instance D conforming to the schema A in its own CMDB A, it may refer to the data of the CMDB D indirectly.

Thus, the first computer system may indirectly detect the information of the configuration items of the second computer system by detecting external reference data of the second computer system. The first computer system may then create an alias CI instance conforming to the schema A from the detected external reference data, and may store the alias CI instance in the CMDB A, thereby managing the data of the second computer system.

The first computer system may not directly refer to the actual data models and the actual relation models of the configuration items to be managed by the second computer system. However, the first computer system may indirectly refer to at least one of the attributes and relations of the configuration items of the second computer system using alias data models 501 and 701 and alias relation models 502 and 704, as described in more detail below.

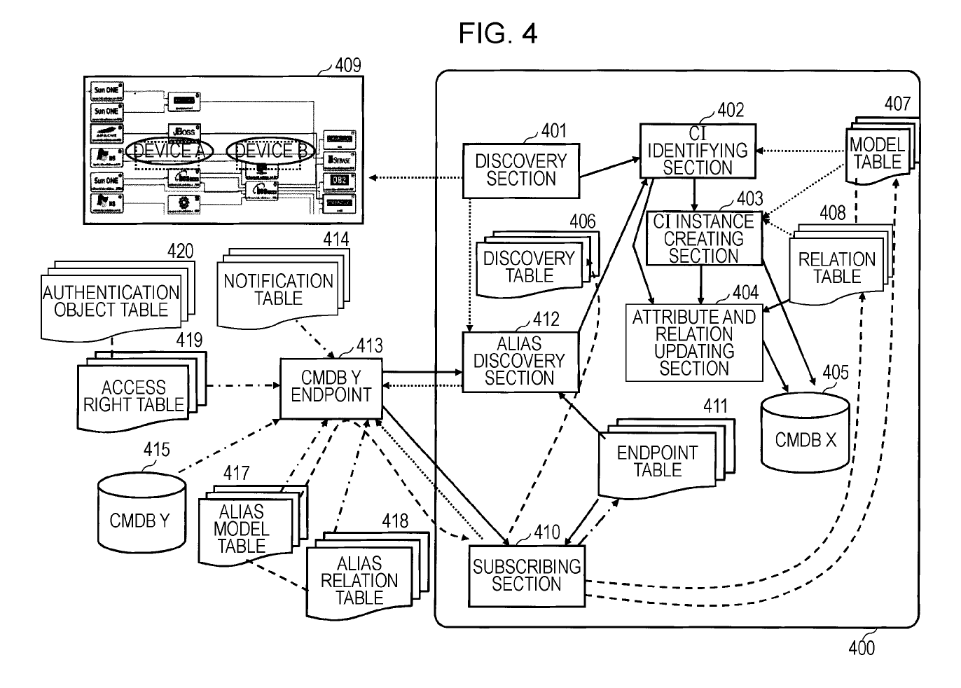

FIG. 4 shows the first computer system and the second computer system according to embodiments of the invention described above with reference to FIG. 3.

In the first embodiment described above with reference to FIG. 3, the first computer system 400 may request the second computer system to allow the first computer system 400 to manage data conforming to the second specification in the second computer system. In response, the first computer system 400 and the second computer system may prepare for discovering and tracking the external reference data of the second computer system.

Upon completing preparation, the second computer system may prepare external reference data associated with the data conforming to the second specification, that is, information of alias CIs. An alias discovery section 412 of the first computer system 400 my then detect the external reference data from the second computer system. A CI instance creating section 403 of the first computer system 400 may create a set of data conforming to the first specification, that is, an alias CI instance from the external reference data. The CI instance creating section 403 may store the created alias CI instance in a CMDB 405 of the first computer system 400. The first computer system 400 may thus manage the information of the configuration items of the second computer system.

In the second embodiment described above with reference to FIG. 3, the second computer system may delegate the management of information regarding the configuration items of the second computer system to the first computer system 400. In response to the delegation, the second computer system and the first computer system 400 may prepare for discovering and tracking the external reference data of the second computer system.

Upon completing preparation, the second computer system may prepare external reference data associated with data conforming to the second specification. The alias discovery section 412 of the first computer system 400 may then detect the external reference data from the second computer system. The CI instance creating section 403 of the first computer system 400 may create a set of data conforming to the first specification, that is, an alias CI instance from the external reference data. The CI instance creating section 403 may store the created alias CI instance in the CMDB 405 of the first computer system 400. The management of information regarding the configuration items of the second computer system may thus be delegated to the first computer system 400.

The configuration items of the first computer system 400 will now be described.

Like the computer system 100 of FIG. 1, the first computer system 400 may include a discovery section 401, a CI identifying section 402, a CI instance creating section 403, an attribute and relation updating section 404, and a CMDB X 405. The first computer system 400 may be connected to another computer system, that is, the second computer system, via a network, such as a cable LAN environment or a wireless LAN environment conforming to a wireless LAN connection standard, such as IEEE802.11a/b/g/n. The second computer system may include a CMDB Y 415. The CI instances stored in the CMDB X 405 and the CI instances stored in the CMDB X 415 may differ in schema. For example, the CMDB X 405 may store a set of data conforming to the first specification, while the CMDB X 415 may store data conforming to the second specification.

The discovery section 401 may corresponds to the discovery section 101 shown in FIG. 1. The discovery section 401 may detect information regarding the CIs to be managed by the first computer system 400. Part of the information may be displayed on a TADDM or other console screen 409. In certain embodiments, the discovery section 401 may call an alias discovery section 412, as described in more detail below, in response to a request to detect external reference data associated with CI information to be managed by the second computer system.

The alias discovery section 412 may be an additional element in certain embodiments. The request to detect external reference data may be issued to, for example, an endpoint 413 of the second computer system. While FIG. 4 shows the discovery section 401 and the alias discovery section 412 separately, the discovery section 401 may also include the function of the alias discovery section 412.

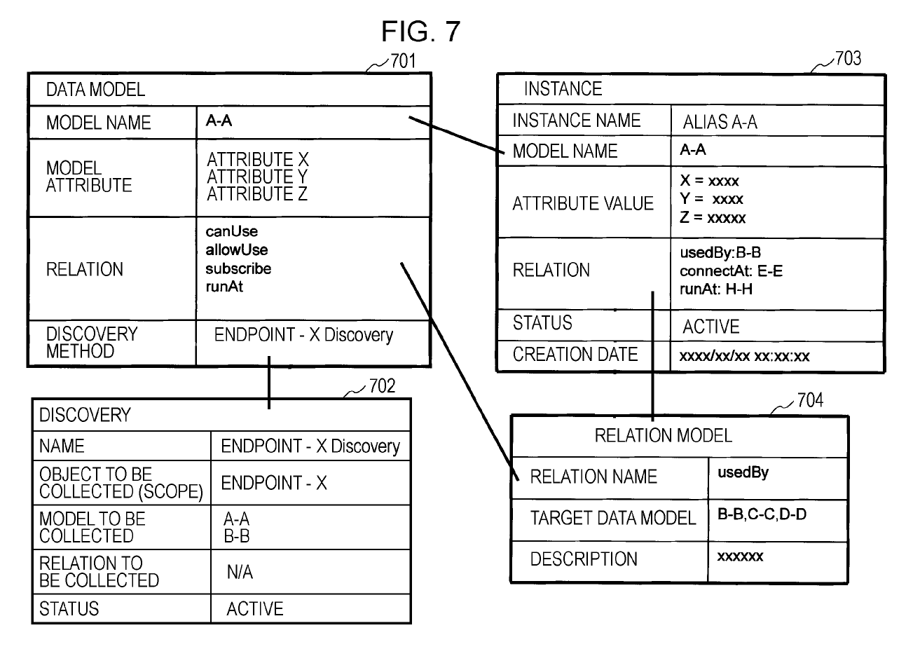

In response to the request, the alias discovery section 412 may acquire the data of object to be collected, model to be collected, and relation to be collected from discovery data 702 (FIG. 7) (hereinafter referred to as “alias discovery data”) stored in a discovery table 406 with reference to a discovery method of a data model 701 (FIG. 7) (also referred to as an “alias data model”) for external reference data. The alias discovery section 412 may further acquire information regarding the endpoint 413 of the second computer system, which is the object to be collected, from an endpoint table 411. Furthermore, the alias discovery section 412 may send information necessary for access authentication, such as user ID and password, to the acquired endpoint information, for example, URL, as necessary. If access is permitted, the alias discovery section 412 may detect external reference data at the endpoint 413. The external reference data may include at least one of the attribute value or relation value of an alias CI. The alias discovery section 412 may pass the detected external reference data to the CI identifying section 402.

The CI identifying section 402 may correspond to the CI identifying section 102 of FIG. 1. The CI identifying section 402 may receive information regarding the CI to be managed by the first computer system 400 from the discovery section 401, and process the detection result. Likewise, the CI identifying section 402 may receive the external reference data from the alias discovery section 412 and process the detection result.

The CI identifying section 402 may determine whether the information of the CI is information regarding a new CI, or an updated attribute value or relation value of an existent CI with reference to the CMDB X 405. If the CI information regards a new CI, the CI identifying section 402 may pass the information to the CI instance creating section 403. In contrast, if the CI information is an updated attribute value or relation value of an existent CI, the CI identifying section 402 may pass the information to the attribute and relation updating section 404.

Likewise, the CI identifying section 402 may determines whether the external reference data is information regarding a new alias CI, or an updated attribute value or relation value of an existent alias CI with reference to the CMDB X 405. When the external reference data regards a new CI, the CI identifying section 402 may pass the external reference data to the CI instance creating section 403. In contrast, when the external reference data regards an updated attribute value or relation value of an existent CI, the CI identifying section 402 may pass the external reference data to the attribute and relation updating section 404.

The CI instance creating section 403 may correspond to the CI instance creating section 103 shown in FIG. 1. The CI instance creating section 403 may create a set of data indicating an attribute of the CI and relationships between the CI and other CIs. This set of data may be created from the information regarding the CI to be managed by the first computer system 400, according to a data model 201 (FIG. 2B) stored in a model table 407 and a relation model 204 (FIG. 2B) stored in a relation table 408. One example of the set of data may be a CI instance.

The CI instance creating section 403 may create a set of data indicative of an attribute of the alias CI and relations with other alias CIs from the external reference data, according to an alias data model 701 (FIG. 7) stored in the model table 407, and an alias relation model 704 (FIG. 7) stored in the relation table 408. An example of the set of data may be an alias CI instance. Since the alias data model 701 (FIG. 7) and the alias relation model 704 (FIG. 7) may conform with the schema of the CMDB X 405, the alias CI instance may also conform with the schema of the CMDB X 405.

The attribute and relation updating section 404 may correspond to the attribute and relation updating section 104 of FIG. 1. The attribute and relation updating section 404 may reflect the updated attribute value or relation value of the CI to be managed by the first computer system 400 to the CI instance of the CI stored in the CMDB X 405. Likewise, the attribute and relation updating section 404 may reflect the updated attribute value or relation value of the external reference data to the alias CI instance stored in the CMDB X 405.

The CMDB X 405 may correspond to the CMDB 105 in FIG. 1. The CMDB X 405 may store the CI instance 203 (FIG. 2B) of a CI to be managed by the first computer system 400 and the alias CI instance. The alias CI instance may conform to the schema of the CMDB X 405. Since the CMDB X 405 stores the alias CI instance, the first computer system 400 may indirectly refer to the data of the second computer system.

The discovery table 406 may correspond to the discovery table 106 of FIG. 1. The discovery table 406 may store the discovery data 202 (FIG. 2B) of the CI to be managed by the first computer system 400. The discovery table 406 may further store the alias discovery data 702 (FIG. 7). The discovery data 202 (FIG. 2B) and the alias discovery data 702 (FIG. 7) may be stored in different discovery tables.

The model table 407 may correspond to the model table 107 of FIG. 1. The model table 107 may store the data model 201 (FIG. 2B) for the CIs to be managed by the first computer system 400. The model table 407 may also store the alias data model 701 (FIG. 7). The data model 201 (FIG. 2B) and the alias data model 701 (FIG. 7) may be stored in different model tables.

The relation table 408 may correspond to the relation table 108 in FIG. 1. The relation table 408 may store the relation model 204 (FIG. 2B) for the CIs to be managed by the first computer system 400. The relation table 408 may also store the alias relation model 704 (FIG. 7). The relation model 204 (FIG. 2B) and the alias relation model 704 (FIG. 7) may be stored in different relation tables.

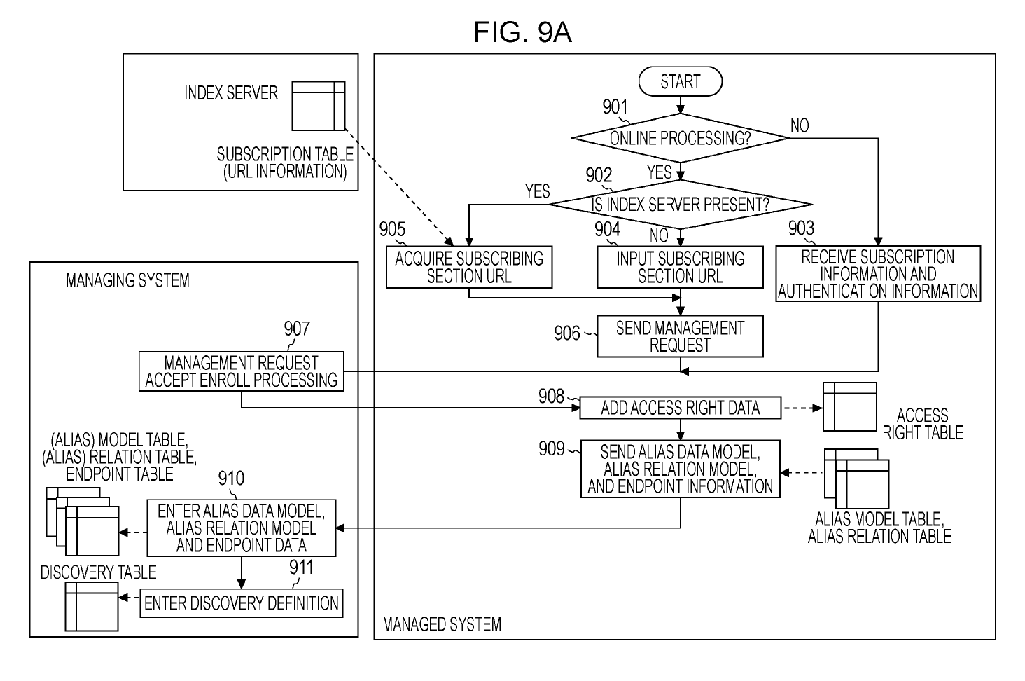

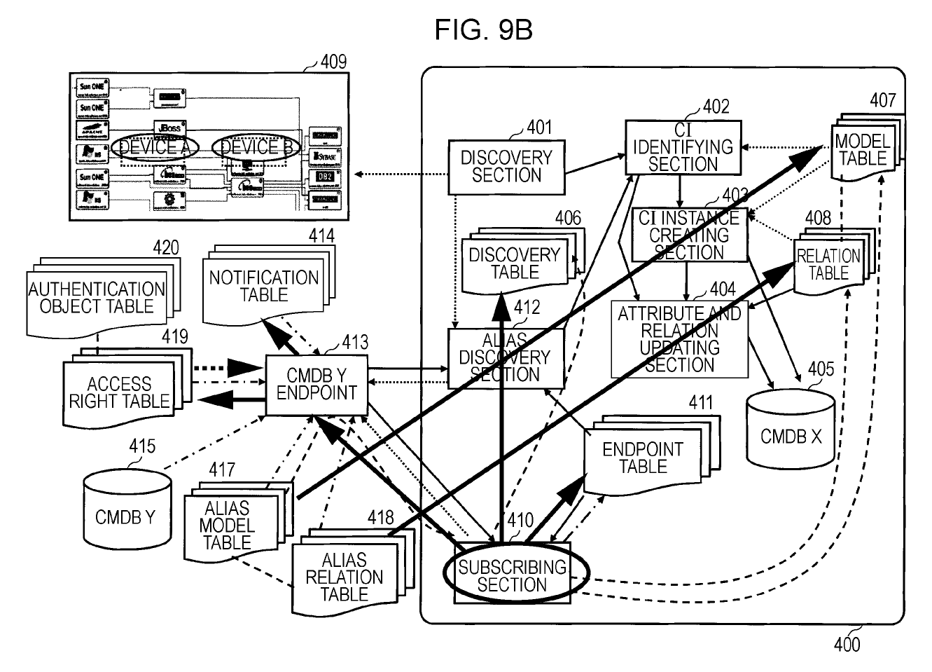

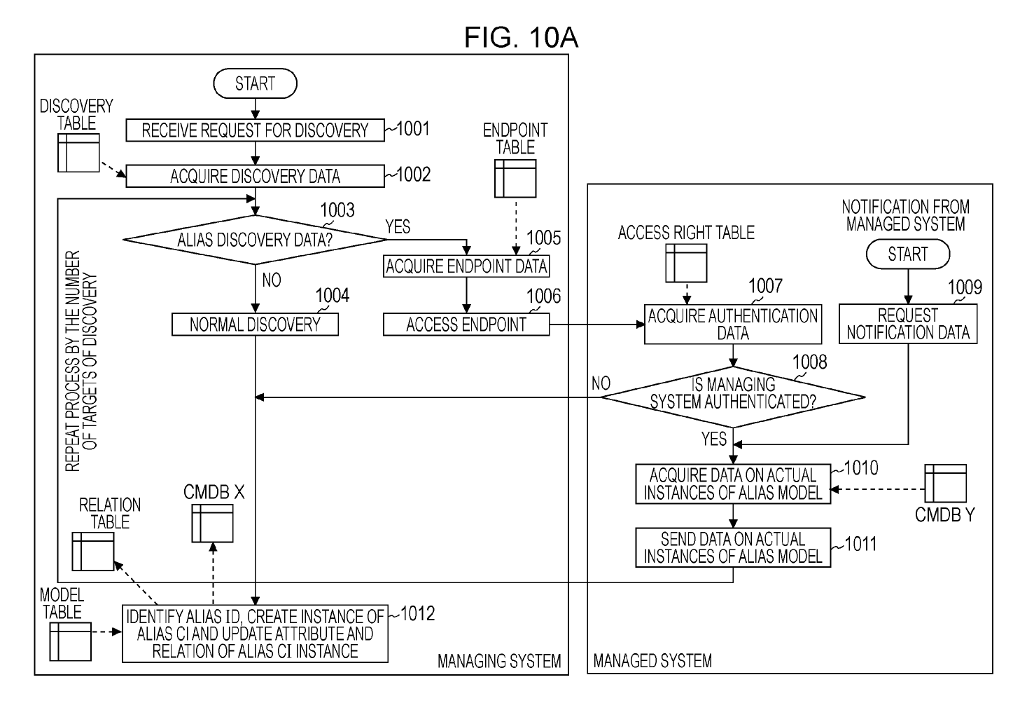

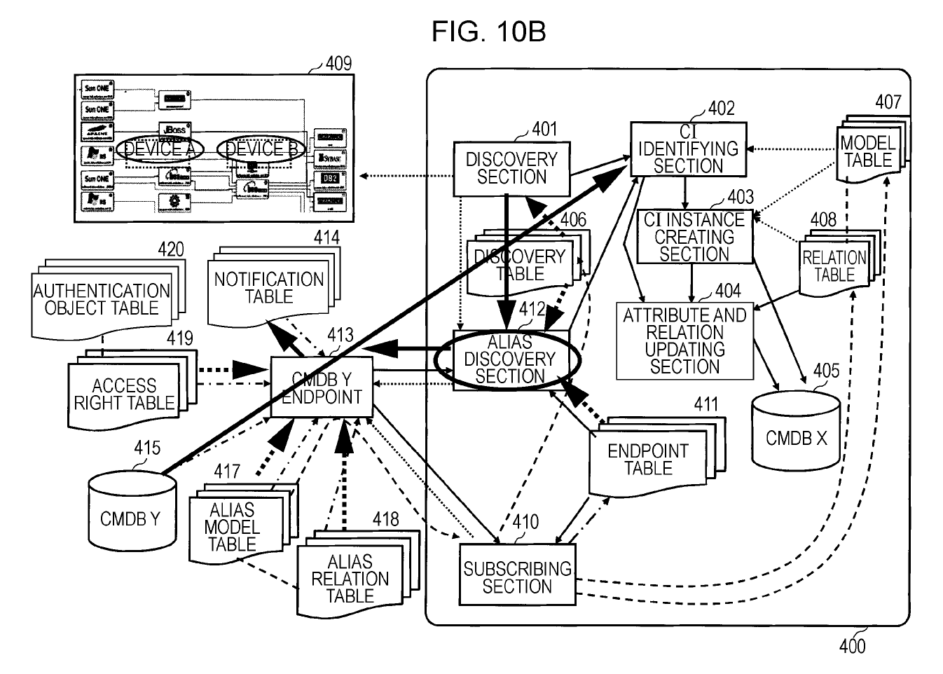

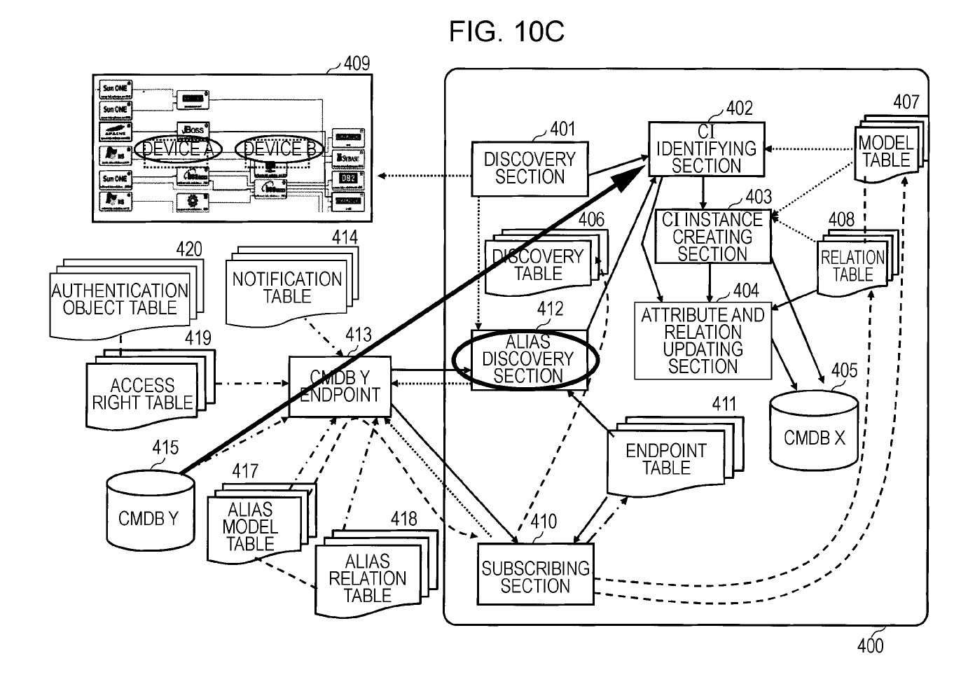

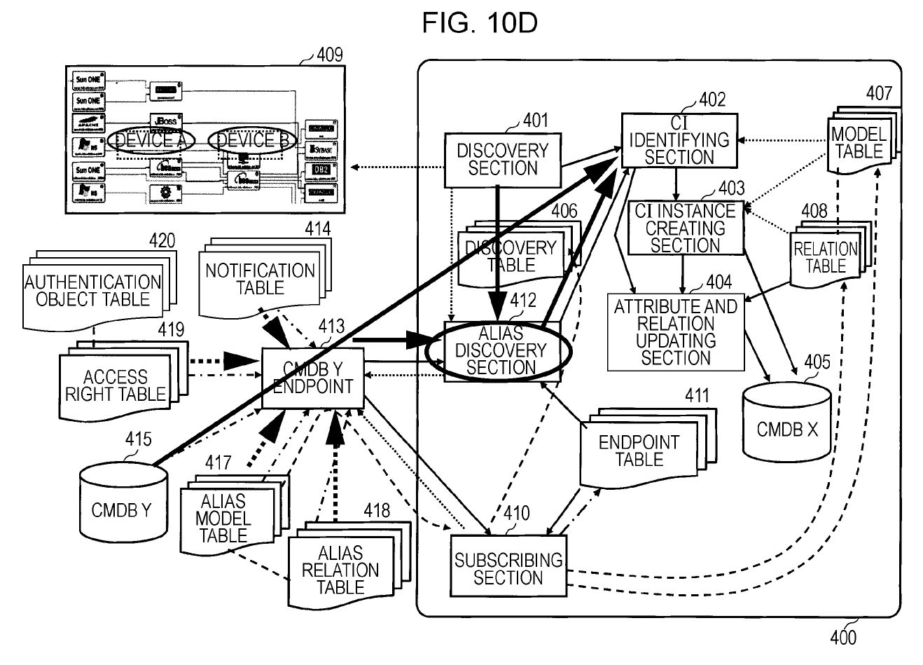

A subscribing section 410 in accordance with certain embodiments of the invention may be added to the first computer system 400. The subscribing section 410 may be used to prepare for detecting external reference data. The details of the function of the subscribing section 410 will be described in more detail with reference to FIGS. 9A to 10D below.

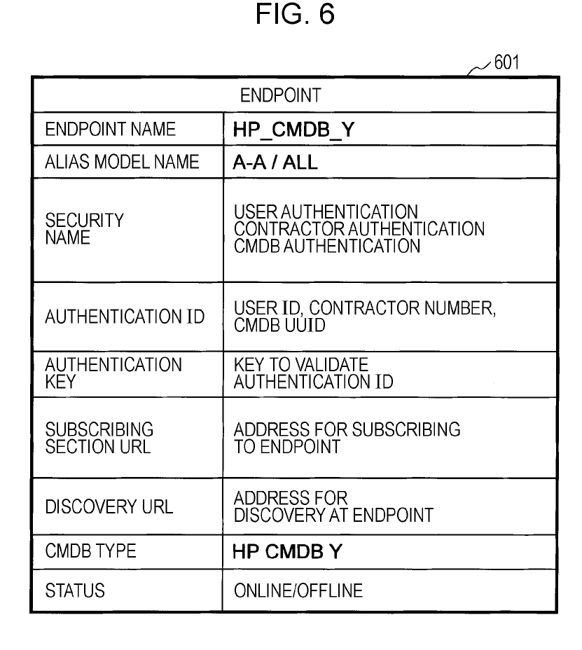

The endpoint table 411 may be added to the first computer system 400. The endpoint table 411 may store endpoint data 601 (FIG. 6) for the endpoint 413, for example, a CMDB Y endpoint, of the second computer system that the first computer system 400 accesses. The details of the endpoint data 601 will be described in more detail with reference to FIG. 6.

In certain embodiments, such as those described with reference to FIG. 4, the second computer system (not shown) may include the endpoint 413, for example, the CMDB Y endpoint 413, an access right table 419, the CMDB Y 415, a notification table 414 (with a desired structure), an alias model table 417, and an alias relation table 418. The access right table 419 may be recorded on either a storage section (not shown) of the second computer system or a storage section of a server system connected to the second computer system.

The endpoint 413 may be used to prepare for the detection of external reference data in certain embodiments. The first computer system 400 may access the endpoint 413 when detecting the external reference data of the second computer system. The endpoint 413 may be prepared in correspondence with the CMDB Y 415. If the second computer includes a plurality of CMDBs, one endpoint may be provided for each CMDB or alternatively, one endpoint may manage the plurality of CMDBs according to the identifiers of the CMDBs. The details of the function of the endpoint 413 will be described later with reference to FIGS. 9A to 10D.

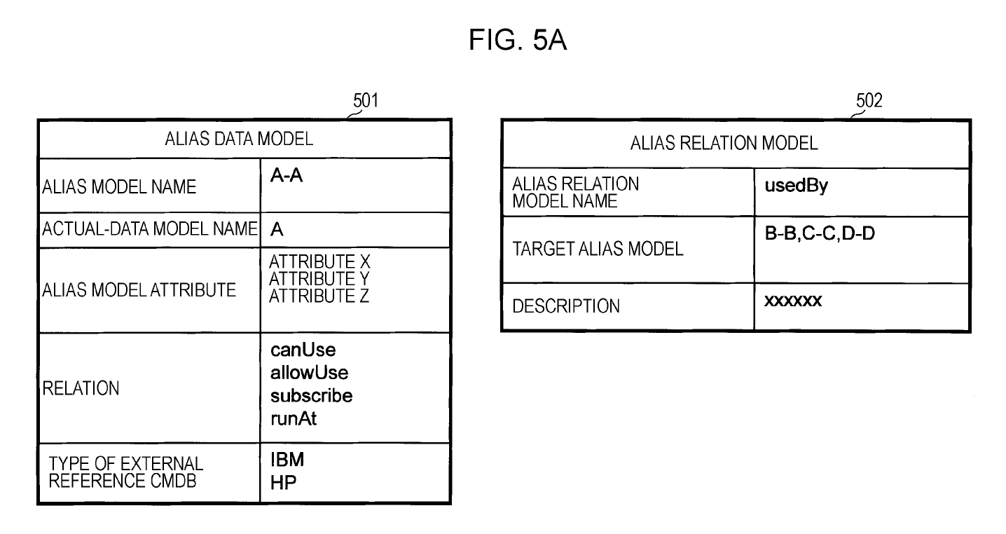

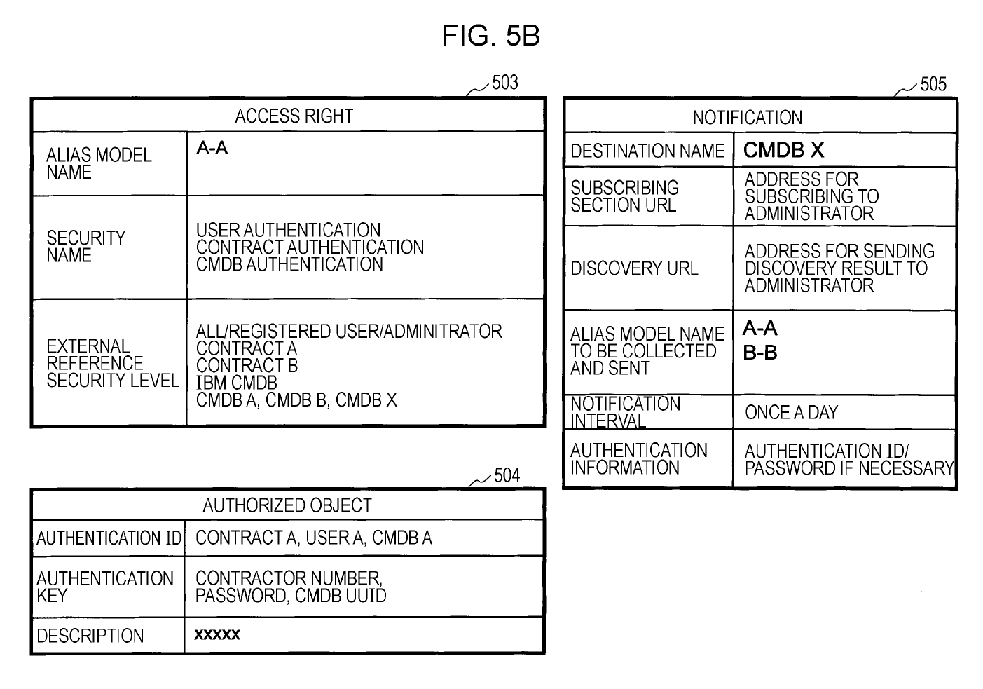

The access right table 419 may store access right data 503. The access right data 503 may describe information of the first computer system 400 which may refer to the external reference data of the second computer system. Details of the access right data 503 will be described later with reference to FIG. 5B.

The CMDB Y 415 may store the CI instances and the alias CI instances of the CIs to be managed by the second computer system. The data stored in the CMDB X 405 and the data stored in the CMDB Y 415 may have different schemas.

The notification table 414 may contain notification data 505. The notification data 505 may be used in the second embodiment. Details of the notification data 505 will be described later with reference to FIG. 5B.

The alias model table 417 may store an alias data model 501. Details of the alias data model 501 will be described later with reference to FIG. 5A.

The alias relation table 418 may store an alias relation model 502. Details of the alias relation table 418 will be described later with reference to FIG. 5A.

Referring now to FIG. 5A, an alias data model 501 may be stored in the alias model table 417 and an alias relation model 502 may be stored in the alias relation table 418 in certain embodiments of the invention. The alias data model 501 may include a schema for defining the external reference data that the first computer system 400 may use when referring to the configuration items to be managed by the second computer system. The administrator of the second computer system may prepare the alias data model 501 in advance and store it in the alias model table 417.

The alias data model 501 may include, for example, an “alias model name,” an “actual data model name,” an “alias model attribute,” a “relation,” and a “type of external reference CMDB.” The “alias model name” may indicate which alias configuration item the model name designates. In FIG. 5A, for example, “alias model name” is A-A. The “alias model name” may be designated by “model to be collected” in the alias discovery data 702 (FIG. 7), as will be described in more detail below. The alias data model 501 may not directly use the data model name of a configuration item to be managed by the second computer system. Therefore, the administrator of the second computer system may control access to the information of configuration items to be referred to.

The “actual data model name” may specify the data model name of the entity of an alias configuration item designated by an alias model name and to be managed by the second computer system. The “actual data model name” may be deleted when it is sent to the first computer system 400, so as not to be referred to by the first computer system 400. Since the first computer system 400 may not directly refer to the actual model name of the second computer system, the administrator of the second computer system may control access to the information of its own configuration items referred to from an external computer system.

The “alias model attribute” may describe the attributes of the alias configuration item designated by the alias model name. The model attributes may be referred to from the first computer system 400.

The “relation” may describe relations between the alias configuration item designated by “alias model name” and other configuration items. A “relation” may include, for example, relations with other alias configuration items such as connectable relations.

The “type of external reference CMDB” may indicate the type of the CMDB from which the alias configuration item designated by “alias model name” may be referred to. The “type of external reference CMDB” may be optionally included.

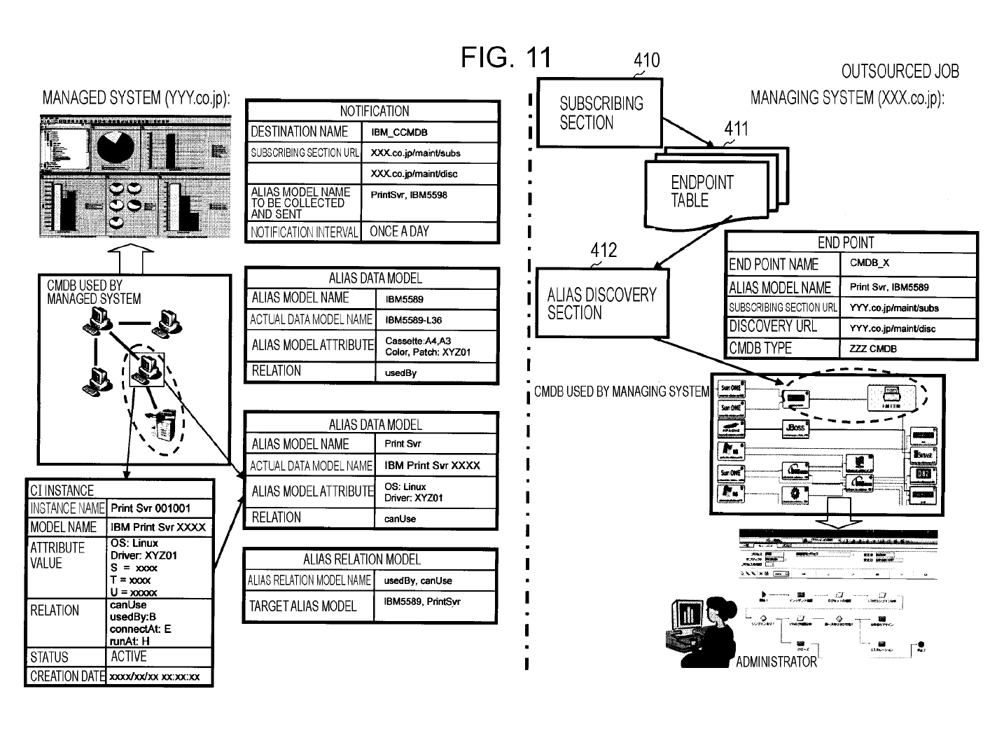

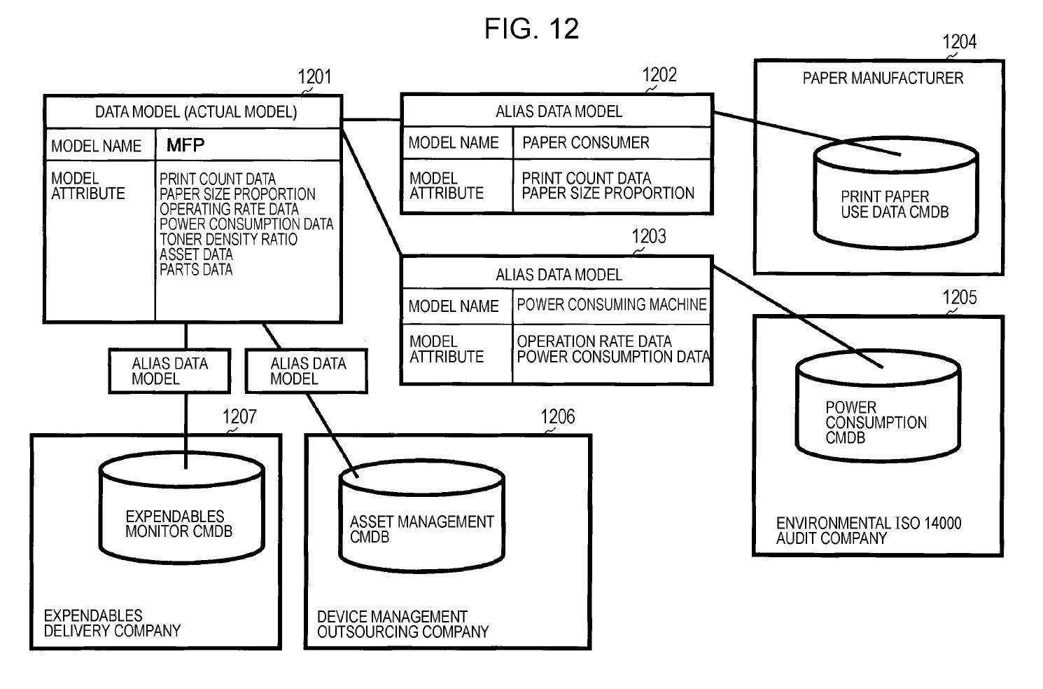

Even if there is one actual data model, a plurality of alias data models 501 may be prepared for an external computer system. This may allow the administrator of the second computer system to provide the first computer system 400 with different views of the actual data model (see FIGS. 11 and 12).

The alias data model 501 may be sent to the first computer system 400 via the endpoint 413 of the second computer system. At the transmission, any attribute unnecessary for the first computer system 400, for example, “actual data model name” and “type of external reference CMDB” may be dynamically deleted. The subscribing section 410 of the first computer system 400 may receive the alias data model 501 and add an attribute necessary for the administrator, for example, “discovery method.” An example of the alias data model is shown in FIG. 7 (701). The alias data model 701 may be used when the CI instance creating section 403 of the first computer system 400 creates a set of data indicative of the attribute of the alias CI and its relations with other alias CIs.

The alias relation model 502 may provide a schema for defining the relation between data models associated with external reference data that the first computer system uses when referring to the configuration items to be managed by the second computer system. The alias relation model 502 may describe only the alias relations that may be referred to from an external computer system. The administrator of the second computer system may prepare the alias relation model 502 in advance, and store it in the alias relation table 418.

The alias relation model 502 may include, for example, “alias relation model name,” “target alias model,” “description,” and the like. Even if there is one actual relation model, a plurality of alias relation models 502 may be prepared for an external computer system. This may allow the administrator of the second computer system to provide the first computer system with different views of the actual relation model (see FIGS. 11 and 12).

The alias relation model 502 may be sent to the first computer system 400 via the endpoint 413 of the second computer system. At the transmission, any attribute unnecessary for the first computer system may be dynamically deleted. The subscribing section 410 of the first computer system 400 may receive the alias relation model 502 and add an attribute necessary for the administrator. One example of the alias relation model 502 is shown in FIG. 7 (704). The alias relation model 704 may be used when the CI instance creating section 403 of the first computer system 400 creates a set of data indicative of the attribute of the alias CI and its relations with other alias CIs.

FIG. 5B shows access right data 503, authorized object data 504, and notification data 505 according to one embodiment of the invention. The access right data 503 may provide a schema for defining whether the first computer system 400 may access the external reference data of the second computer system. The access right data 503 may include, for example, “alias model name,” “security name,” and “external reference security level.”

The “alias model name” may indicate which alias configuration item the model name designates. In the present example, the “alias model name” may be A-A. The alias model A-A may be the alias model of the configuration item A to be managed by the second computer system, as defined by the actual model name of the alias data model 501. The “alias model name” may be an item common to the alias data model 501.

The “security name” may include at least one of user authentication, contract authentication, and CMDB authentication. A plurality of securities may be defined in one alias data model 501.

The “external reference security level” may specify an attribute of an object that may refer to the CMDB Y 415. Attributes of the object may be specified by the name of the first computer system, the user, the administrator, the type of contract (for example, contract A or contract B), the type of CMDB (for example, specified by company name, e.g., IBM CMDB), and/or the name of CMDB (for example, CMDB A, CMDB B, or CMDB X). The access right data 503 may be stored in the access right table 419.

The authorized object data 504 may be a schema of the information of the first computer system 400 that is permitted to refer to the CMDB Y 415 of the second computer system. The authorized object data 504 may be stored in, for example, an authorized access table (not shown). The authorized object data 504 may include, for example, an “authentication ID,” an “authentication key,” “description,” and the like. The “authentication ID” may permit a reference request, and may indicate, for example, a contract type, a user name, a CMDB name, and the like. The “authentication key” may provide a key for authenticating a reference request, and may indicate, for example, a contract number, a password, a CMDB universally unique identifier (“UUID”), and the like.

The notification data 505 may be sent from the endpoint 413 of the second computer system to the subscribing section 410 of the first computer system 400 when management of the external reference data associated with the CMDB Y 415 of the second computer system is delegated to the first computer system 400. The notification data 505 may include, for example, a “destination name,” a “subscribing section URL,” a “discovery URL,” an “alias model name to be collected and sent,” a “notification interval,” “authentication information,” and the like.

Particularly, the “destination name” may indicate the name of the first computer system or the name of the CMDB X 405 of the first computer system 400. The “subscribing section URL” may indicate the URL of the subscribing section 410 of the first computer system 400. The “discovery URL” may indicate the URL of the alias discovery section 412 of the first computer system 400. The “alias model name to be collected and sent” may indicate an alias model name sent from the endpoint 413 of the second computer system to the subscribing section 410 of the first computer system 400. The “notification interval” may indicate the interval of notification to the first computer system 400. Finally, the “authentication information” may indicate an authentication ID and password when authentication is required.

Referring now to FIG. 6, endpoint data 601 may be stored in the endpoint table 411. The endpoint data 601 may include, for example, “endpoint name,” “alias model name,” “security name,” “authentication ID,” “authentication key,” “subscribing section URL,” “discovery URL,” “CMDB type,” “status,” and the like.

The “endpoint name” may indicate the name of the endpoint 413 of the second computer system. The “alias model name” may indicate which of the alias configuration items the model name designates. The alias model name may designate individual model names or all the alias model names. The “security name” may include, for example, user authentication, contract authentication, and CMDB authentication. The security name may agree with the security name on the access right data 503 (FIG. 5B).

The “authentication ID” may indicate, for example, user ID, contract number, and CMDB UUID. The “authentication key” may indicate a key for use in verifying the authentication ID. The “subscribing section URL” may indicate a location name for subscribing to the endpoint 413 of the second computer system, for example, the URL of the endpoint 413. The “discovery URL” may indicate a location name for detecting the endpoint 413 of the second computer system by the discovery section 401, for example, the URL of the endpoint 413. The “CMDB type” may indicate the name of the CMDB Y 415 of the second computer system or the specification of the CMDB Y 415. The “status” may indicate the status of the CMDB at the time of detection by the discovery section 401.

FIG. 7 shows an alias data model 701, a discovery data 702, an alias CI instance 703, and an alias relation model 704 according to certain embodiments of the invention. The alias data model 701, the alias discovery data 702, the alias CI instance 703, and the alias relation model 704 may be used by the first computer system 400 for storing the external reference data detected from the second computer system in its own CMDB as a CI instance.

The alias data model 701 may be stored in the model table 407. The alias discovery data 702 may be stored in the discovery table 406. The alias CI instance 703 may be stored in the CMDB X 405. The alias relation model 704 may be stored in the relation table 408.

The alias data model 701 may be a schema for defining alias configuration items. The alias data model 701 may be designated by an attribute of the alias discovery data 702, “model to be collected,” described in more detail below. Accordingly, when the alias discovery section 412 detects the external reference data in the second computer system, the alias data model 701 may be used. The alias data model 701 may also be used when an alias CI instance is created from the detected external reference data.

The alias data model 701 may include, for example, a “model name” indicative of which alias CI the model name designates, a “model attribute” indicative of the attribute of the alias CI designated by the model name, a “relation” indicative of the relations between the alias CI designated by the model name and other CIs (including alias CIs), and a “discovery method” that specifies a discovery instance for detecting the alias CI designated by the model name. The alias data model 701 may be specified by the name of the discovery instance (see “instance name” in the alias CI instance 703 of FIG. 7). In the case of FIG. 7, the name of the discovery instance is “endpoint-X Discovery”. In some embodiments, the alias data model 701 may be created from the alias data model 501, as described above.

The alias discovery data 702 may be used when external reference data is detected by the alias discovery section 412. The alias discovery data 702 (FIG. 7) may be implemented by an instance of static data or a Java® class instance. The alias discovery data 702 may include a “name” of a discovery instance specified by the discovery method in the alias data model 701, an “object to be collected (scope)” indicative of the endpoint of the second computer system, which may be collected by the alias discovery section 412, a “model to be collected” and “relation to be collected” for the alias CI of the second computer system, which may be collected by the alias discovery section 412, and a “status” indicative of whether the discovery instance is active or inactive. The alias discovery data 702 may designate a plurality of endpoints as the objects to be collected. Further, in some embodiments, the alias discovery data 702 may extract all the relations, without specifying the relation to be collected, by setting the attribute value of the relation to be collected to “N/A.”

The alias CI instance 703 may correspond to the CI instance 203 of FIG. 2B. For the first computer system 400, in one embodiment, there may be no need to distinguish between the CI instance 203 and the alias CI instance 703.

The alias relation model 704 may correspond to the relation model 204 of FIG. 2B. For the first computer system 400, in one embodiment, there may be no need to distinguish between the relation model 204 and the alias relation model 704. The alias relation model 704 may be created from the alias relation model 502, as described above. The alias relation model 704 may be used when an alias CI instance is created from the detected external reference data.

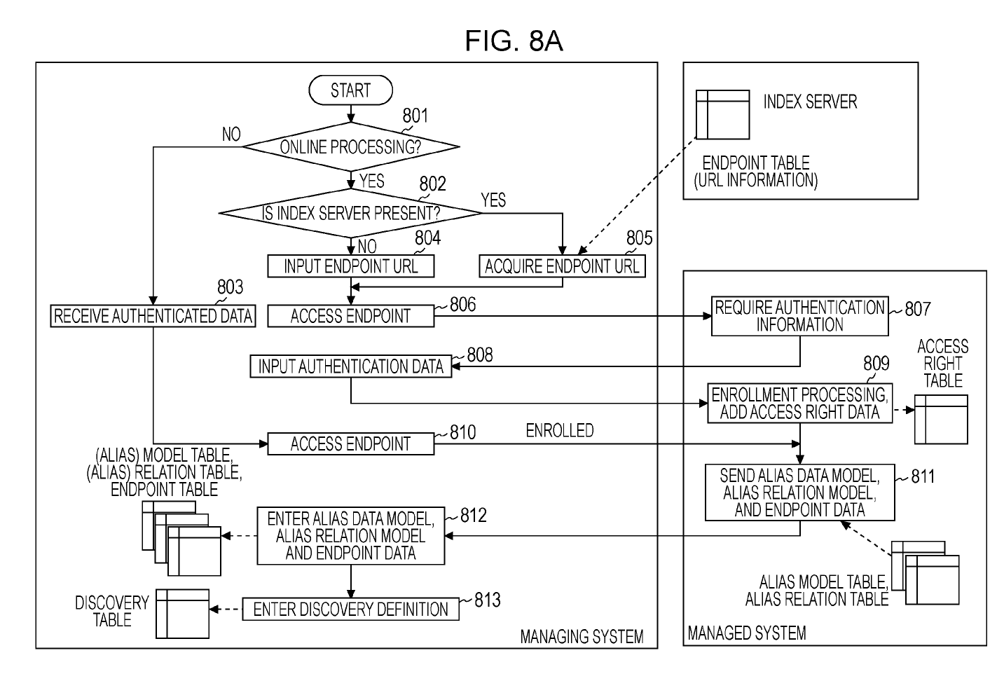

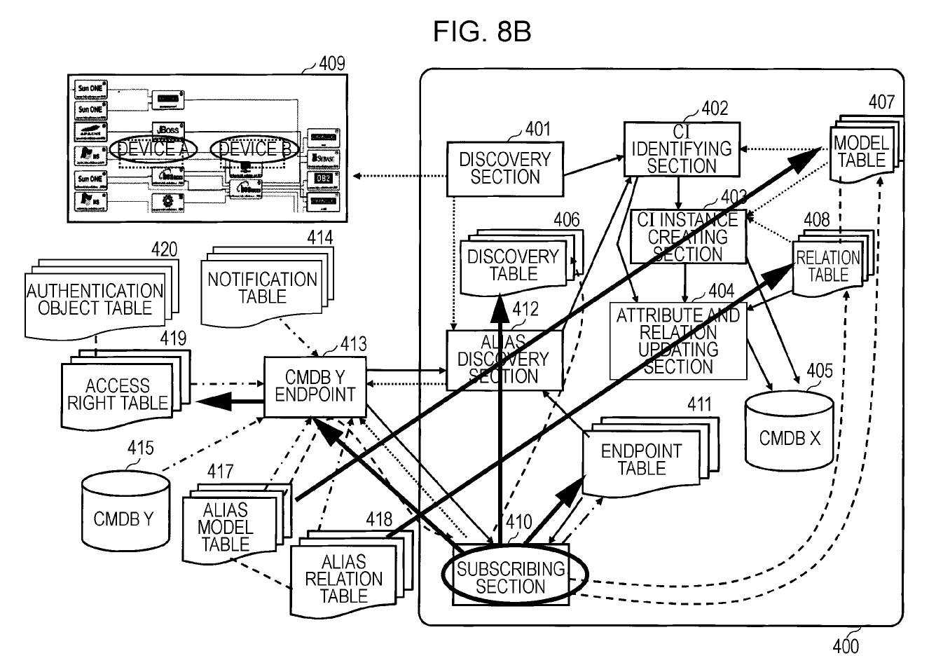

FIG. 8A is a flowchart of an embodiment of the invention in which the first computer system 400 (managing system) works the second computer system (managed system) to manage the data of the second computer system. The managing system may determine whether to process access permission to the managed system online 801.

When processing access permission online, the subscribing section 410 of the managing system may determine whether there is an index server (or a center server) including an endpoint table that stores information about the endpoint 413 of the managed system to acquire the endpoint data 802. The endpoint data may include information for specifying the location of the managed system. Examples of endpoint data may include uniform resource locator (“URL”), IP address, and MAC address of the endpoint, and the like.

If the index server is present, the subscribing section 410 may acquire endpoint data from the index server 805. The managing system may access the endpoint of the managed system according to the endpoint data 806. At the access, the subscribing section 410 may send an authentication request to the endpoint 413 of the managed system to access the endpoint 413. The online access permission processing may also be referred to as online enrollment. Alternatively, the subscribing section 410 may request access permission for the managed system, as online enrollment, by accessing a sever system that implements dedicated access authentication from the managing system.

For the online enrollment, a lightweight directory access protocol (“LDAP”), which is an existing authentication system, may be used. The endpoint 413 of the managed system may request the subscribing section 410 of the managing system to send authentication information, for example, user ID, password, and if necessary, security level and contract level. In response to the request, the managing system may input authentication information 808. When the authentication information is authorized, the endpoint 413 may add 809 the access right data 503 of the managing system to the access right table 419.

In contrast, when processing access permission not in online mode, that is, in offline mode, the managing system may read authentication information that has already been authenticated to access the managed system from the storage section (not shown) 803. The offline access permission processing may also be referred to as offline enrollment. In the offline enrollment, the managing system (or its administrator) may have permission to access the managed system enrolled by the managed system (or its administrator) in advance, and the managing system may receive authentication information from the managed system offline in advance. Examples of the authentication information may include user ID, password, security or contract levels, and CMDB data of the managed system. The authentication information may also include which alias model information of the managed system the managing system acquires.

The managed system may request the first computer system 400 to regularly send notification of the authentication information from the managing system. Then, the subscribing section 410 of the managing system may send the already authenticated authentication information to the endpoint 413 of the managed system according to the endpoint data stored in the storage section (not shown) 810.

The endpoint 413 of the managed system may read the alias data model 501 and the alias relation model 502 from the alias model table 417 and the alias relation table 418, respectively. When sending the read alias data model 501 and alias relation model 502 to the managing system, the endpoint 413 may dynamically delete attributes unnecessary for the managing system, for example, “actual data model name” or “type of external reference CMDB.”

Alternatively, the endpoint 413 may read the alias relation model 502 that is associated with the alias data model 501 and prepared for transmission to the managing system in advance from the alias model table 417. This may allow the managed system to conceal attributes secret from the managing system or delete unnecessary attributes for simplification. Likewise, the endpoint 413 may delete unnecessary attributes of the alias relation model 502, as necessary. The endpoint 413 may send the alias data model 501 and the alias relation model 502 to the subscribing section 410 of the managing system 811. The endpoint 413 may also send endpoint data to the subscribing section 410 of the managing system 811.

The subscribing section 410 of the managing system may receive the alias data model 501, the alias relation model 502, and the endpoint data sent from the managed system. When storing the received alias data model 501 in the model table 407, the subscribing section 410 may add a necessary attribute for the managing system, for example, “discovery method.” The subscribing section 410 may store the alias data model 501, the alias relation model 502, and the endpoint data in the model table 407, the relation table 408, and the endpoint table 411, respectively 812. The managing system may prepare the alias discovery data 702 according to the model table 407, the relation table 408, and the endpoint table 411, and may store 813 the alias discovery data 702 in the discovery table 406. In this embodiment, preparation of the managing system for discovering and tracking the external reference data may thus be completed.

FIG. 8B is a conceptual diagram of an embodiment of the invention in which the managing system works the second computer system to manage the data of the managed system. Thick arrow lines show the data flow in the process steps described above with reference to FIG. 8A.

FIG. 9A is a flowchart of another embodiment of the invention in which the second computer system (managed system) works the first computer system 400 (managing system) to manage the data of the second computer system. In this embodiment, the managed system may determine whether to process access permission to the managing system online 901.

When processing access permission online, the endpoint 413 of the managed system may determine whether there is an index server (or a center server) including a subscription table that stores subscription information of the managing system to which management is delegated, for example, the URL of the subscription, to acquire the subscription information 902. If the index server is present, the endpoint 413 may acquire endpoint data from the index server 905. If no index server is present, the endpoint 413 may request the administrator of the managed system to input subscription information. In response to the request, the administrator may input the subscription information directly to a web browser, or may call a file that describes the subscription information 904.

The managed system may send a request for delegating the management (hereinafter, a “management delegation request”) to the subscribing section 410 of the managing system according to the subscription information 906. The management delegation request may further include a request for information about which alias model management is to be delegated to the first computer system 400. The management delegation request may include, for example, the endpoint data and the information of the CMDB Y 415 of the managed system.

At the transmission of the management delegation request, the endpoint 413 may send an authentication request to access the subscribing section 410 of the managing system as necessary. The subscribing section 410 may process the authentication request from the managed system. The subscribing section 410 may request the managed system to send authentication information, for example, user ID, password, and if necessary, security level and contract level. In response to the management delegation request, the subscribing section 410 may request the endpoint 413 of the managed system to add access right of the managing system 907. In response to the request, the endpoint 413 of the managed system may add 908 the access right data 503 of the managing system to the access right table 419.

In contrast, when processing access permission not in online mode, that is, in offline mode, the managed system may read authentication information that has already been authenticated to access the managing system from the storage section (not shown) 903. The offline access permission processing may also be referred to as offline enrollment. Then, the endpoint 413 of the managed system may send the management delegation request and the authenticated authentication information to the subscribing section 410 of the managing system according to the subscription information stored in the storage section (not shown) 903. Alternatively, the endpoint 413 of the managed system may send only the management delegation request to the subscribing section 410 of the managing system.

The subscribing section 410 of the managing system may receive the management delegation request and the authentication information. The subscribing section 410 may recognize the management delegation request and authentication information sent from the managed system, and may determine an alias model that can be managed as necessary. The subscribing section 410 may request the endpoint 413 of the managed system to add the access right of the managing system in response to the reception of the management delegation request and authentication information 907. In response to the request, the endpoint 413 of the managed system may add 908 the access right data 503 of the managing system to the access right table 419. The subscribing section 410 may send information of an alias data model that can be managed, together with the request to add the access right.

The endpoint 413 of the managed system may read the alias data model 501 and the alias relation model 502 from the alias model table 417 and the alias relation table 418, respectively, according to the information of the alias data model sent from the subscribing section 410 of the managing system. When sending the read alias data model 501 and alias relation model 502 to the managing system, the endpoint 413 may dynamically delete attributes unnecessary for the managing system, for example, “actual data model name” and “type of external reference CMDB.”

Alternatively, the endpoint 413 may read the alias relation model 502 associated with the alias data model 501 and prepared for transmission to the managing system in advance from the alias model table 417. This may allow the managed system to conceal attributes secret from the managing system, or delete unnecessary attributes for simplification. Likewise, the endpoint 413 may delete unnecessary attributes of the alias relation model 502. The endpoint 413 may send the alias data model 501 and the alias relation model 502 to the subscribing section 410 of the managing system 909. The endpoint 413 may also send endpoint data to the subscribing section 410 of the managing system 909.

The subscribing section 410 of the managing system may receive the alias data model 501, the alias relation model 502, and the endpoint data sent from the managed system. When storing the received alias data model 501 in the model table 407, the subscribing section 410 may add a necessary attribute for the managing system, for example, “discovery method.” The subscribing section 410 may store the alias data model 501, the alias relation model 502, and the endpoint data in the model table 407, in the relation table 408, and in the endpoint table 411, respectively 910. The managing system may prepare the alias discovery data 702 according to the model table 407, the relation table 408, and the endpoint table 411, and may store 911 the alias discovery data 702 in the discovery table 406. In this embodiment, the preparation of the managing system for discovering and tracking the external reference data of the managed system may thus be completed.

FIG. 9B is a conceptual diagram of an embodiment of the invention in which the managed system works the managing system to manage the data of the managed system. Thick arrow lines show the data flows in the process steps described above with reference to FIG. 9A.

FIG. 10A is a flowchart of the foregoing embodiments of the invention in which the managing system detects the external reference data of the managed system. First, detection in the first embodiment will be described.

The discovery section 401 may receive a discovery request 1001. In response to the discovery request, the discovery section 401 may acquire the alias discovery data 702 in the discovery table 406. The discovery section 401 may determine 1003 whether the discovery request is for discovery to the endpoint of the managed system (alias discovery) from the object to be collected in the alias discovery data 702. If it is not alias discovery but detection of the information of a CI to be managed by the managing system, the discovery section 401 may executes the detection 1004.

If it is alias discovery, the discovery section 401 may call the alias discovery section 412. The alias discovery section 412 may acquire 1005 the endpoint data 601 to be accessed from the endpoint table 411. The alias discovery section 412 may send authentication information to the endpoint data, for example, endpoint URL, and may access the endpoint 413 of the managed system 1006. In response to reception of the authentication information from the managing system, the endpoint 413 of the managed system may acquire 1007 the access right data 503 in the access right table 419.

The endpoint 413 may perform authentication of the managing system according to the access right data 503. If the authentication is successful, the endpoint 413 may acquire an attribute value and a relation value, that is, external reference data, which may include the target of detection of actual instances, defined in the alias data model 701 and the alias relation model 704, from the CMDB Y 415. The endpoint 413 may prepare the external reference data at the endpoint, and may send it in response to a request from the alias discovery section 412 of the managing system 1011.

The endpoint 413 may either acquire the attribute value and the relation value from the CMDB X 415 in response to the discovery request from the managing system, or may regularly update the attribute value and relation value of actual instances defined in the alias data model 501 and the alias relation model 502 irrespective of the discovery request from the managing system. The update may be achieved by the discovery function of the managed system.

The alias discovery section 412 may pass the external reference data detected in the managed system to the CI identifying section 402. The CI identifying section 402 may receive the external reference data from the alias discovery section 412, and may process the detection result. The CI identifying section 402 may determine whether the external reference data is the information of new external reference data, or an updated attribute or relation value of existent external reference data with reference to the CMDB X 405. The determination may be performed, for example, by comparing the CI instance name that is instantiated from external reference data stored in the CMDB X 405 with the detected external reference data. If the external reference data is new external reference data, the CI identifying section 402 may pass the external reference data to the CI instance creating section 403. In contrast, if the external reference data is an updated attribute or relation value of existent external reference data, the CI identifying section 402 may pass the external reference data to the attribute and relation updating section 404.

The CI instance creating section 403 may create a set of data indicative of an attribute of the CI and relations with other CIs from the external reference data according to the alias data model 701 stored in the model table 407 and the alias relation model 704 stored in the relation table 408. The set of data may conform with the specification of the data of the managing system. The set of data may be instantiated according to the external reference data detected by the alias discovery section 412, or may manually input external reference data (see FIG. 2A). The set of data may be implemented by, for example, an instance of static data or a Java® class instance.

An example of the set of data my include an (alias) CI instance. An example of the (alias) CI instance is shown in FIG. 7 (denoted by numeral 703). The set of data may be stored in the CMDB X 405. The set of data may be such that both an attribute and a relation are provided in the (alias) CI instance, or alternatively, an attribute may be provided in the (alias) CI instance and a relation may be stored in the CMDB X 405. In the latter case, the (alias) CI instance may include a link for specifying a related relation instance.

The attribute and relation updating section 404 may achieve tracking together with the alias discovery section 412. The attribute and relation updating section 404 may reflect the updated attribute or relation of the external reference data to the (alias) CI instance of the alias CI stored in the CMDB X 405. In other words, the attribute and relation updating section 404 may update the value of the attribute or relation of the (alias) CI instance of the alias CI. The update may be executed by replacing the value with the external reference data detected by the alias discovery section 412. All of the attribute or relation values of the (alias) CI instance may be replaced with the external reference data detected by the alias discovery section 412, or different values only may be replaced. The CMDB X 405 of the managing system may store the alias CI instance 703.

Detection according to a second embodiment of the invention will now be described.

The endpoint 413 of the managed system may acquire the notification data 505 from the access right table 419 in response to a management delegation request 1009. The notification data 505 may include subscription information of the managing system to be notified, information of discovery URL of the managing system, alias model name to be notified, and notification interval. The endpoint 413 may acquire the attribute value and relation value of the alias model defined as an alias model name to be notified, from the actual instance stored in the CMDB Y 415 according to the notification interval of the notification data 505 (1010). The endpoint 413 may provide the acquired attribute value and relation value, that is, external reference data, to the alias discovery section 412 of the managing system 1011.

The alias discovery section 412 may receive the external reference data, and pass the received external reference data to the CI identifying section 402. The remaining steps may be substantially the same as the first embodiment.

FIGS. 10B and 10C show the concept of the first embodiment of the invention in which the managing system may detect the external reference data of the managed system. Thick arrow lines show the data flow in the process steps described with reference to FIG. 10A.

FIG. 10D shows the concept of the second embodiment of the invention in which the managing system may detect the external reference data of the managed system. Thick arrow lines show the data flow in the process steps described above with reference to FIG. 10A.

FIG. 11 depicts an embodiment of the invention in which the maintenance of a device, for example, a printer is outsourced. As shown, a managed system (YYY.co.jp) may desire to manage only the job information of the printer to be managed, and outsource the maintenance of the printer to a managing system (XXX.co.jp). However, the data schema of the CMDB that the managing system uses may be different from that of the managed system. Embodiments of the invention may be applied to solve this problem.

Particularly, the CMDB used by the managed system may store the actual instance of the printer (instance name: Print Svr 001001). The actual instance may have attributes “OS,” “Driver,” “S,” “T,” and “U.” The alias model table of the managed system may store the alias data model of the actual instance. The alias data model may include part of the attributes of the actual instance, “OS” and “Driver.” The reason the alias data model may include part of the attributes of the actual instance is that only attributes necessary for the maintenance of the printer may be detected by the managing system.

The subscribing section 410 of the managing system may prepare for detecting the attribute value and relation value of the alias model of the printer from the managed system. After completion of the preparation, the alias discovery section 412 of the managing system may acquire the endpoint information of the managed system from the endpoint table. The managing system may access the endpoint of the managed system according to the endpoint information, and may acquire information necessary for the maintenance of the printer, that is, external reference data, from the endpoint of the managed system.

The managing system may create an alias CI instance from the acquired external reference data, and store the alias CI instance in its own CMDB. The created alias CI instance may conform to the data schema of the CMDB of the managing system. Thus, the managing system may manage the data necessary for maintenance of the printer of the managed system using its own CMDB.

The managing system may execute a management process necessary for the maintenance of the printer of the managed system using the CMDB. The managing system may send maintenance personnel to the managed system as required. Thus, the managing system may maintain the printer belonging to the managed system, and the managed system may outsource maintenance of the printer to the managing system.

FIG. 12 shows an embodiment of the invention in which device information, for example, printer information, may be shared by a plurality of CMDBs. The managed system may include a data model (actual data model) of the printer to be managed. The attributes of the data model may include, for example, “print count data,” “paper size proportion,” “operating rate data,” “power consumption data,” “toner density ratio,” “asset data,” and “parts data.” The managed system may prepare alias data models 1202, 1203, which may include part of the attributes of the actual data model, in its own alias model table 417. Examples of the alias data models may include an alias data model 1202 including the attributes “print count data” and “paper size proportion,” and an alias data model 1203 including the attributes “operating rate data” and “power consumption data.”

The subscribing section 410 of the managing system may prepare for detecting the attribute values and the relation values of the alias models of the printer from the managed system. After completion of the preparation, the alias discovery section 412 of the managing system may acquire the endpoint information of the managed system from the endpoint table.

The alias discovery section 412 of a computer system 1204 of a paper manufacturer, which may be a managing system, may detect the external reference data for the alias data model 1202. However, the alias discovery section 412 may not be able to detect the external reference data for the alias data model 1203. Likewise, the alias discovery section 412 of a computer system 1205 of an environmental ISO 14000 audit company, which may also be a managing system, may detect the external reference data for the alias data model 1203. However, the alias discovery section 412 may also not be able to detect the external reference data for the alias data model 1202.

The managed system may manage the disclosure of the referenced information by creating multiple alias models from one actual data model. The managed system may allow an external managing system that manages a CMDB of a different schema to manage the configuration items under the management of the managed system.

In addition to the embodiment of the invention shown in FIG. 12, other embodiments may include, for example, integration of different CMDBs of multiple departments of a company, integration of different CMDBs of multiple departments after business merger, and integration of CMDBs of companies, for example, integration of CMDBs with a partner company.

A computer used in the computer system of the above-described embodiments may include a CPU and a main memory, which may be connected to a bus. The CPU may be based on a 32-bit or 64-bit architecture, which can use, for example, Xeon™ series, Core™ series, Pentium™ series, and Celeron™ series of Intel Corporation, and Phenom™ series and Athlon™ series of Advanced Micro Devices, Inc. The bus may be connected to a display, such as an LCD monitor, via a display controller. The display may be used for displaying information of a computer connected to a network via a communication line, and information of software operating on the computer, through an appropriate graphic interface, so as to control the computer system. The bus may also connect to a hard disk or a silicon disk and a CD-ROM or DVD drive via an IDE or SATA controller.

The hard disk may store an operating system, a program for providing a Java® processing environment such as J2EE, a CMDB operation management program and other programs, and data in such a manner that they can be loaded on the main memory. The operation management program may include Tivoli® Application Dependency Discovery Manager (“TADDM”) available from International Business Machines Corporation.

The CD-ROM or DVD drive may also be used for installing a program to the hard disk as necessary. The bus may also be connected to a keyboard or mouse via a keyboard or mouse controller.

The communication interface may comply with, for example, the Ethernet protocol. The communication interface may be connected to the bus via a communication controller to connect the computer and the communication line physically, and provide a network interface layer to the TCP/IP protocol of the communication function of the operating system of the computer. The communication line may adopt a cable LAN environment or a wireless LAN environment based on a wireless LAN connection standard such as IEEE802.11a/b/g/n.

Examples of a network connection device used for connection with hardware such as computers are, in addition to the foregoing network switch, a router and a hardware management console. In other words, the network connection device may return configuration information, such as an IP address and MAC address, of a computer connected to another computer that installs a network operation management program in response to an inquiry, using a predetermined command from the other computer. The network switch and router may include an address resolution protocol (“ARP”) table including a list of address pairs. Each address pair may consist of an IP address of a computer connected thereto and a corresponding MAC address, and may return the content of the ARP table in response to an inquiry using a predetermined command. In some embodiments, the hardware management console may return more detailed configuration information of a computer than the ARP table.

The above-described hardware management console may be connected to the computer. The hardware management console may logically partition one computer into multiple partitions by LPAR, and by running different OSs such as Windows™ and Linux™ in each partition by VMware®. This may allow the information in the individual logical partitions of the computer operating on LPAR/VMware® to be acquired in detail by inquiring from the hardware management console systematically.

While certain embodiments of the invention have been described above with particularity, it will be understood by those skilled in the art that the descriptions of the embodiments are merely examples of the invention and that various modifications may be made without departing from the technical scope of the invention. For example, the invention may use not only CMDB and CIs stored therein, but also another form of data base and CIs. Also, the invention may use, in addition to Java®, any computer development environment, such as C++ and C#, which may invoke an API having a network management function.

1. A system for managing a plurality of configuration items, the system comprising:
a first computer managing configuration items conforming to a first specification;
a second computer managing configuration items conforming to a second specification, wherein the second computer is connected to the first computer over a network;
a repository storing, for each of the configuration items, a set of data conforming to the first specification, the set of data comprising at least one predetermined attribute of each configuration item and at least one relationship between each configuration item and other configuration items; and
a discovery section for detecting external reference data associated with each configuration item conforming to the second specification, wherein the set of data for each configuration item conforming to the second specification is created from the external reference data and stored in the repository.

2. The system of claim 1, further comprising:
a determining section for determining whether the set of data created from the external reference data has been stored in the repository;
an updating section for updating an attribute value and a relation value of the set of data to an attribute value and a relation value of the external reference data, upon determining that the set of data has been stored in the repository; and
a data creating section for creating the set of data from the external reference data upon determining that the set of data has not been stored in the repository.

3. The system of claim 2, further comprising:
a model table for storing a first data model defining at least one predetermined attribute of each configuration item and its relations with other configuration items,
wherein the model table further stores a second data model defining at least one predetermined attribute of the external reference data and relations with other configuration items, the second data model being used for creating the set of data from the external reference data.

4. The system of claim 3, wherein the external reference data is instantiated to the set of data conforming to the first specification according to the second data model.

5. The system of claim 3, further comprising a relation table storing a first relation model defining relations between the configuration items, wherein the relation table further stores a second relation model defining relations between data models associated with the external reference data.

6. The system of claim 5, further comprising a receiving section for receiving the second data model and the second relation model from the second computer.

7. The system of claim 1, further comprising a discovery table for storing discovery data defining an object to be detected when the discovery section detects the external reference data.

8. The system of claim 7, wherein the discovery table further comprises a data model name of the external reference data associated with each configuration item conforming to the second specification.

9. The system of claim 1, further comprising an endpoint table for storing data defining the location accessed by the discovery section to detect the external reference data.

10. (canceled)

11. A method for managing a plurality of configuration items, the method comprising:
managing, by a first computer, configuration items conforming to a first specification;
managing, by a second computer, configuration items conforming to a second specification, wherein the first computer and the second computer are connected via a network;
storing, in a repository, a first set of data conforming to the first specification for each configuration item, the first set of data comprising at least one predetermined attribute of each configuration item and at least one relationship between each configuration item and other configuration items;
detecting external reference data associated with at least one of the configuration items conforming to the second specification;
creating, from the external reference data, a second set of data conforming to the first specification, wherein the second set of data comprises at least one predetermined attribute of each of the at least one configuration items conforming to the second specification, and at least one relationship between each of the at least one configuration items and other configuration items; and
storing the second set of data in the repository.

12. The method of claim 11, further comprising:
determining whether the second set of data has been previously stored in the repository;
updating an attribute value and a relation value of the second set of data to an attribute value and a relation value of the external reference data if the second set of data has been previously stored; and
creating the second set of data from the detected external reference data if the second set of data has not been previously stored.

13. The method of claim 11, further comprising instantiating the detected external reference data to the second set of data according to a data model for the external reference data, the data model defining at least one predetermined attribute of the external reference data and relationships between each configuration item and other configuration items, wherein the data model is used to create the second set of data from the external reference data.

14. The method of claim 13, further comprising receiving the data model for the external reference data from the second computer.

15. The method of claim 14, wherein receiving further comprises receiving a plurality of data models, wherein each of the plurality of data models is a different data model of a same configuration item to be managed.

16. The method of claim 14, further comprising receiving a relation model for the external reference data from the second computer, the relation model defining relations between data models associated with the external reference data.

17. The method of claim 11, wherein detecting further comprises referring to a discovery table that defines objects to be detected.

18. The method of claim 17, wherein the discovery table comprises a data model name corresponding to the external reference data.

19. The method of claim 11, further comprising receiving data defining a location accessible to detect the external reference data.

20. A computer program product for managing a plurality of configuration items, the computer program product comprising:
a computer-usable medium having computer-usable program code embodied therein, the computer-usable program code comprising:
computer-usable program code for managing, by a first computer, configuration items conforming to a first specification;
computer-usable program code for managing, by a second computer, configuration items conforming to a second specification, wherein the first computer and the second computer are connected via a network;
computer-usable program code for storing, in a repository, a first set of data conforming to the first specification for each configuration item, the first set of data comprising at least one predetermined attribute of each configuration item and at least one relationship between each configuration item and other configuration items;
computer-usable program code for detecting external reference data associated with at least one of the configuration items conforming to the second specification;
computer-usable program code for creating, from the external reference data, a second set of data conforming to the first specification, wherein the second set of data comprises at least one predetermined attribute of each of the at least one configuration items conforming to the second specification, and at least one relationship between each of the at least one configuration items and other configuration items; and
computer-usable program code for storing the second set of data in the repository.
